(19) United States
(12) Patent Application Publication
(10) Pub. No.: US 2026/0264215 A1
(43) Pub. Date: Sep. 10, 2026

(54) TOOL SUPPORT DEVICE

(71) Applicant: NAGAKI SEIKI CO., LTD., Osaka (JP)

(72) Inventors: Keitarou OBA, Miyagi (JP); Takashi MIYAKO, Miyagi (JP); Shingo KIMURA, Osaka (JP)

(21) Appl. No.: 19/167,010

(22) PCT Filed: Mar. 15, 2024
(86) PCT No.: PCT/JP2024/010156

§ 371 Date: Sep. 19, 2025

(30) Foreign Application Priority Data
Mar. 20, 2023 (JP) 2023-043973

(51) Int. Cl. B25J 1/12; B66F 11/04; F16M 13/02

(52) U.S. Cl. CPC B25J 1/12; F16M 13/022; B66F 11/044

(57) ABSTRACT

An object is to provide a tool support device that can facilitate fixing and adjustment of an angle of a second arm relative to a first arm. The tool support device includes: first arm member; second arm member; first lock mechanism; and first unlocking member. The first lock mechanism has pressing member, pressed part pressed by the pressing member, engagement protruding parts arranged on one of the pressing member and the pressed part, second engagement parts arranged in the other of the pressing member and the pressed part, and first pushing member configured to push the pressing member in first direction toward the pressed part so that engagement between engagement protruding parts and second engagement parts is maintained. The first unlocking member includes first motion member that moves the pressing member in second direction opposite to the first direction against pushing force applied by the first pushing member.

### TECHNICAL FIELD

The present invention relates to a tool support device.

### BACKGROUND ART

Tool support devices for supporting a tool are known.

As a related art, Patent Literature 1 discloses an indirect live-line tool support device for aerial work platforms. The indirect live-line tool support device disclosed in Patent Literature 1 includes a base unit, an arm member, and a gripping device. The gripping device includes a first support member having a first gripping part, a second support member having a second gripping part, and a spacer member. In the indirect live-line tool support device disclosed in Patent Literature 1, when the diameter of a gripped part of the indirect live-line tool is a first diameter, the first gripping part and the second gripping part grip the gripped part of the indirect live-line tool without the spacer member therebetween. In contrast, when the diameter of the gripped part of the indirect live-line tool is a second diameter smaller than the first diameter, the first gripping part and the second gripping part grip the gripped part of the indirect live-line tool via the spacer member therebetween. Further, the indirect live-line tool support device disclosed in Patent Literature 1 includes a brake device that brakes swinging of a first arm and a second arm. When the brake lever is not being manipulated, the brake device restricts relative rotation between an outer ring and an inner ring by frictional force, resulting in a locked state where the swinging of the second arm relative to the first arm is braked. In contrast, when the brake lever is manipulated, relative pivoting between the outer ring and the inner ring is enabled, resulting in an unlocked state where the swinging of the second arm relative to the first arm is allowed.

### CITATION LIST

### Patent Literature

Patent Literature 1: Japanese Patent Application Laid-Open No. 2020-79140

### SUMMARY OF INVENTION

### Technical Problem

However, the brake device disclosed in Patent Literature 1 has a problem of inability of easily performing fixing of an angle of the second arm relative to the first arm and adjustment of the angle.

An object of the present invention is to provide a tool support device that can easily perform fixing of an angle of the second arm relative to the first arm and adjustment of the angle.

### Solution to Problem

The present invention relates to a tool support device described below.

(1) A tool support device including:
a first arm member;
a second arm member supported pivotably by the first arm member;
a first lock mechanism configured to lock pivoting of the second arm member relative to the first arm member by engagement between a plurality of engagement protruding parts and a plurality of second engagement parts; and
a first unlocking member configured to unlock the pivoting of the second arm member relative to the first arm member locked by the first lock mechanism,
wherein the first lock mechanism has
when one of the first arm member and the second arm member is defined as a first member, and the other of the first arm member and the second arm member is defined as a second member, a pressing member coupled to the second member so as to be nonrotatable relative to and linearly movable relative to the second member,
a pressed part arranged in the first member and pressed by the pressing member,
the plurality of engagement protruding parts arranged on one of the pressing member and the pressed part,
the plurality of second engagement parts arranged in the other of the pressing member and the pressed part, and
a first pushing member configured to push the pressing member in a first direction toward the pressed part so that the engagement between the plurality of engagement protruding parts and the plurality of second engagement parts is maintained, and
wherein the first unlocking member includes a first motion member configured to move the pressing member in a second direction opposite to the first direction against pushing force applied by the first pushing member.

(2) The tool support device according to (1) above,
wherein the first arm member supports the second arm member so that the second arm member is pivotable about a first axis parallel to the first direction, and
wherein the engagement between the plurality of engagement protruding parts and the plurality of second engagement parts supports at least a part of torque about the first axis acting on the first arm member from the second arm member.

(3) The tool support device according to (2) above, wherein the plurality of second engagement parts include a plurality of engagement holes that receive the plurality of engagement protruding parts or a plurality of engagement recesses that receive the plurality of engagement protruding parts.

(4) The tool support device according to (2) above, wherein the plurality of second engagement parts are arranged at equal angular intervals about the first axis.

(5) The tool support device according to (1) above further including a friction plate coupled to the first member so as to be nonrotatable relative to and linearly movable relative to the first member,
wherein the first pushing member presses the pressing member in the first direction via the friction plate.

(6) The tool support device according to (2) above further including:
a first friction plate; and
a second friction plate in contact with the first friction plate,
wherein the first friction plate is rotatable relative to the pressing member about the first axis, is nonrotatable relative to the pressed part about the first axis, and is movable relative to the pressed part in a direction parallel to the first axis,
wherein the second friction plate is rotatable relative to the pressed part about the first axis, is nonrotatable relative to the pressing member about the first axis, and is movable relative to the pressed part in a direction parallel to the first axis, and
wherein the first pushing member presses the pressing member in the first direction via the first friction plate and the second friction plate.

(7) The tool support device according to (1) above further including a second pushing member configured to push the pressing member in the second direction,
wherein second pushing force of the second pushing member is smaller than the pushing force of the first pushing member.

(8) The tool support device according to (1) above,
wherein the pressing member has a receiving member that receives acting force from the first motion member, and
wherein the receiving member is configured to be repositioned between a first position and a second position, the first position enabling motion of the first motion member to be converted into unlocking of pivoting of the second arm member relative to the first arm member, and the second position disabling the motion of the first motion member to be converted into unlocking of pivoting of the second arm member relative to the first arm member.

(9) The tool support device according to any one of (1) to (8) above further including a first wire for manipulating the first motion member.

(10) The tool support device according to any one of (1) to (8) above further including a base unit configured to be directly attached to a bucket of an aerial work platform,
wherein in a state where the base unit is directly attached to the bucket, the entire base unit is configured so as to be slidably movable with respect to the bucket.

(11) The tool support device according to (10) above,
wherein the base unit has
a first lateral motion member movable in a lateral direction along an inner side face while being in contact with the inner side face of the bucket,
a second lateral motion member movable in a lateral direction along an outer side face while being in contact with the outer side face of the bucket, and
a third lateral motion member movable in a lateral direction along a top face while being in contact with the top face of the bucket. (12) The tool support device according to (9) above further including:
a third arm member supported pivotably about a second axis by the second arm member;
a second lock mechanism configured to lock pivoting of the third arm member relative to the second arm member;
a second unlocking member configured to unlock the pivoting of the third arm member relative to the second arm member locked by the second lock mechanism;
a second wire for manipulating the second unlocking member;
a base unit;
a coupling member coupled to the base unit and configured to support the first arm member pivotably about a third axis;
a third lock mechanism configured to lock pivoting of the first arm member relative to the coupling member;
a third unlocking member configured to unlock the pivoting of the first arm member relative to the coupling member locked by the third lock mechanism;
a third wire for manipulating the third unlocking member; and
a foot pedal or a hand lever connected to the first wire, the second wire, and third wire via a fourth wire,
wherein the tool support device is configured such that unlocking of pivoting of the second arm member relative to the first arm member, unlocking of pivoting of the third arm member relative to the second arm member, and unlocking of pivoting of the first arm member relative to the coupling member are performed at once by manipulation of the foot pedal or the hand lever.

(13) The tool support device according to any one of (1) to (8) above further including:
an attachment having a gripping tool; and
an attachment part, the attachment being configured to be attached to the attachment part,
wherein the attachment is configured to be attached to the attachment part with one-touch operation.

### ADVANTAGEOUS EFFECTS OF INVENTION

According to the present invention, a tool support device that can easily perform fixing of an angle of the second arm relative to the first arm and adjustment of the angle can be provided.

### BRIEF DESCRIPTION OF DRAWINGS

FIG. 1 is a general side view schematically illustrating a portion of a tool support device of a first embodiment.

FIG. 2 is a general sectional view schematically illustrating a portion of the tool support device of the first embodiment.

FIG. 3 is a general sectional view schematically illustrating a portion of the tool support device of the first embodiment.

FIG. 4 is a general sectional view schematically illustrating a portion of a tool support device of a first modified example of the first embodiment.

FIG. 5 is a general sectional view schematically illustrating a portion of a tool support device of a second modified example of the first embodiment.

FIG. 6 is a general perspective view schematically illustrating a portion of the tool support device of the first embodiment.

FIG. 7 is an arrow A-A sectional view in FIG. 2.

FIG. 8 is a general sectional view schematically illustrating a portion of the tool support device of the first embodiment.

FIG. 9 is a general sectional view schematically illustrating a portion of a tool support device of a third modified example of the first embodiment.

FIG. 10 is a general sectional view schematically illustrating a portion of the tool support device of the third modified example of the first embodiment.

FIG. 11 is an arrow B-B sectional view in FIG. 9.

FIG. 12 is a general sectional view schematically illustrating a portion of a tool support device of a fourth modified example of the first embodiment.

FIG. 13 is a general perspective view schematically illustrating a portion of a tool support device of a fifth modified example of the first embodiment.

FIG. 14 is a general sectional view schematically illustrating a portion of a tool support device of a sixth modified example of the first embodiment.

FIG. 15 is a general sectional view schematically illustrating a portion of the tool support device of the sixth modified example of the first embodiment.

FIG. 16 is a general sectional view schematically illustrating a portion of a tool support device of a seventh modified example of the first embodiment.

FIG. 17 is a general sectional view schematically illustrating a portion of the tool support device of the seventh modified example of the first embodiment.

FIG. 18 is an arrow C-C sectional view in FIG. 16.

FIG. 19 is an arrow D-D sectional view in FIG. 16.

FIG. 20 is a general two-side view schematically illustrating a tool support device of a second embodiment.

FIG. 21 is a general sectional view schematically illustrating a portion of the tool support device of the second embodiment.

FIG. 22 is a general side view schematically illustrating a portion of the tool support device of the second embodiment.

FIG. 23 is a diagram schematically illustrating a view in which the entire base unit of the tool support device is slidably movable with respect to a bucket.

FIG. 24 is a general perspective view schematically illustrating the tool support device of the second embodiment.

FIG. 25 is a general sectional view schematically illustrating a portion of the tool support device of the second embodiment.

FIG. 26 is a general sectional view schematically illustrating a portion of the tool support device of the second embodiment.

FIG. 27 is a general plan view schematically illustrating the tool support device of the second embodiment.

FIG. 28 is a general sectional view schematically illustrating a portion of the tool support device of the second embodiment.

FIG. 29 is a general sectional view schematically illustrating a portion of the tool support device of the second embodiment.

FIG. 30 is a diagram schematically illustrating a view in which the tool support device has a foot pedal.

FIG. 31 is a diagram schematically illustrating a view in which a plurality of unlocking members are manipulated collectively by a single foot pedal.

FIG. 32 is a general side view schematically illustrating the tool support device of the second embodiment.

FIG. 33 is a diagram schematically illustrating a view in which a plurality of unlocking members are manipulated respectively by a plurality of foot pedals.

FIG. 34 is a general side view schematically illustrating a tool support device of a third embodiment.

FIG. 35 is a diagram schematically illustrating a view in which an attachment is attached to an attachment part of the tool support device with one-touch operation.

FIG. 36 is a general two-side view schematically illustrating one example of the attachment.

FIG. 37 is a diagram illustrating a view in which the attachment can be attached selectively to a first part of a remote manipulation tool or a second part of the remote manipulation tool.

FIG. 38 is a diagram illustrating a view in which the position of an engagement member of the attachment can be changed between an advanced position that enables engagement with the attachment part of the tool support device and a retracted position that disables the engagement with the attachment part.

### DESCRIPTION OF EMBODIMENTS

A tool support device 1 of the embodiment will be described below in detail with reference to the drawings. Note that, in the present specification, members having the same type of functions are labeled with the same or similar references. Further, for the members labeled with the same or similar references, duplicated description thereof may be omitted.

### First Embodiment

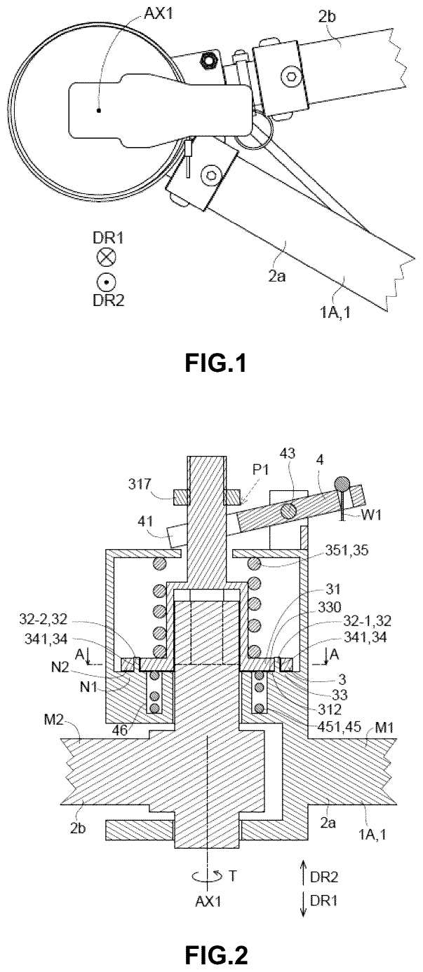

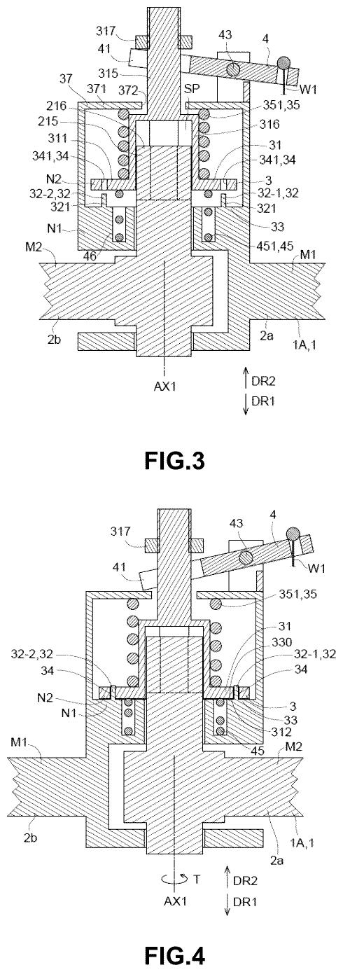

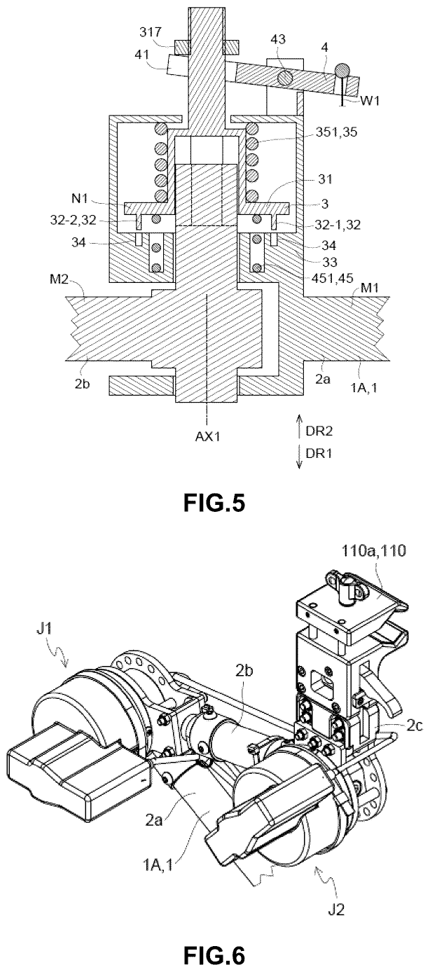

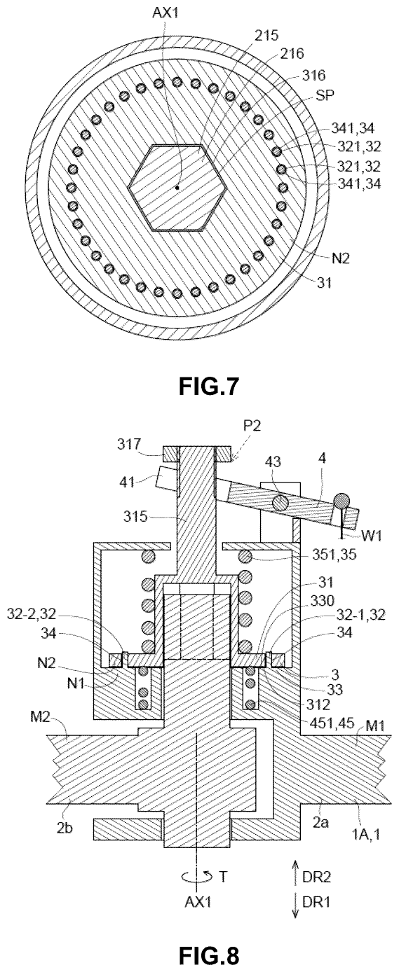

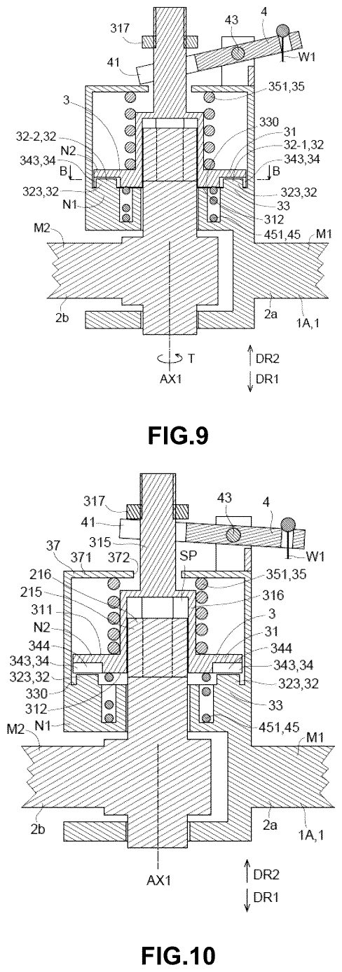

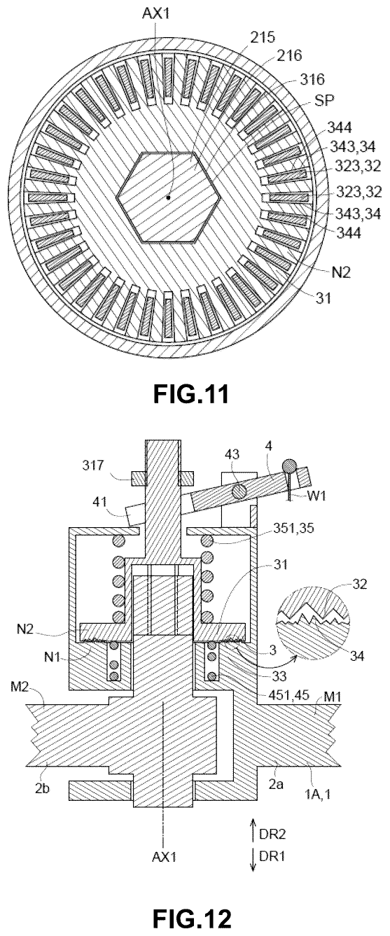

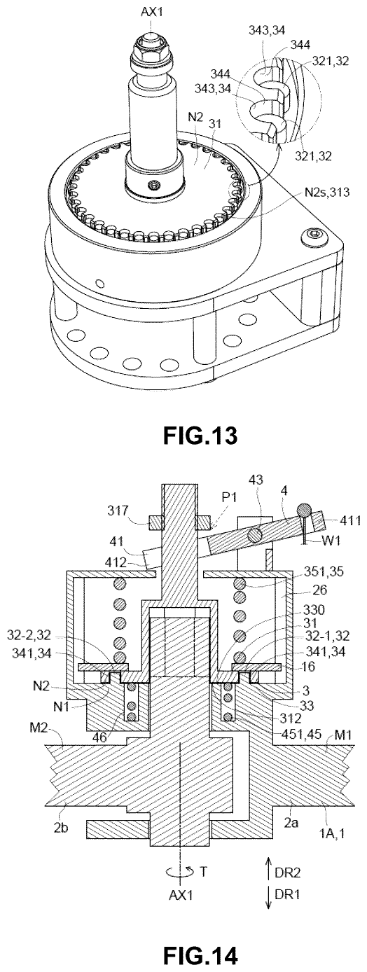

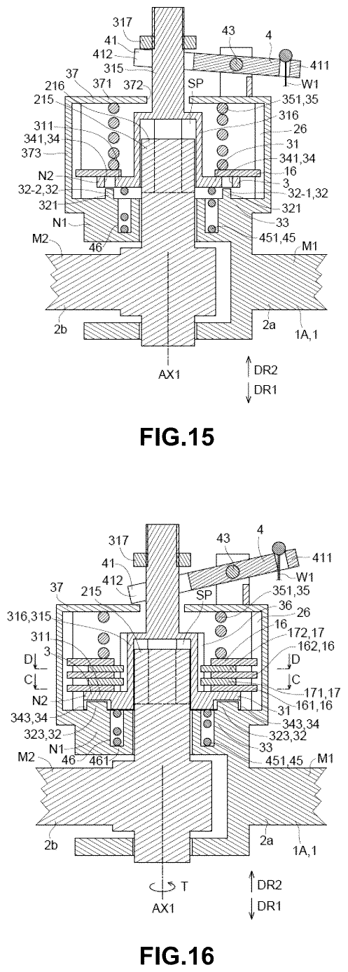

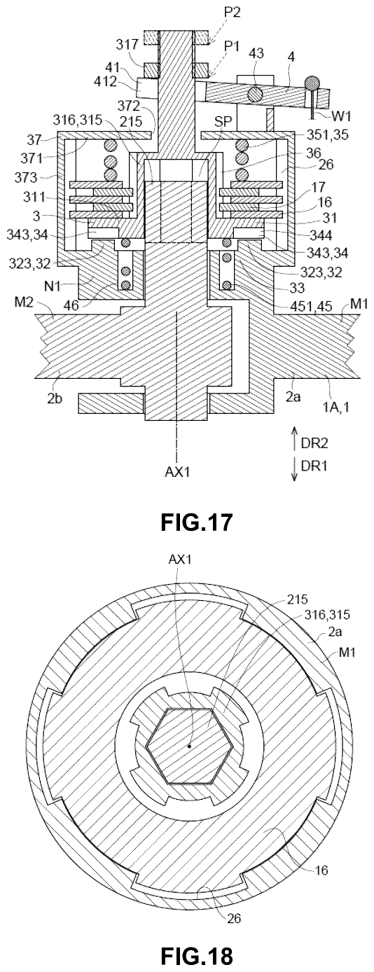

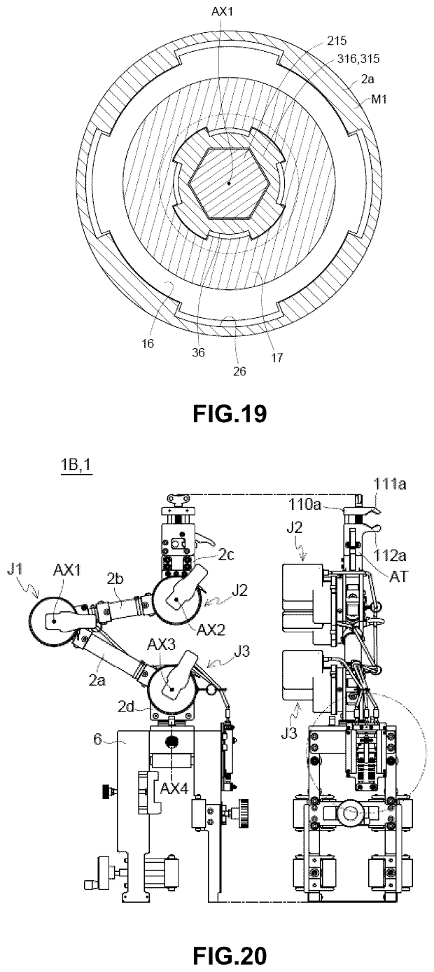

A tool support device 1A of a first embodiment will be described with reference to FIG. 1 to FIG. 19. FIG. 1 is a general side view schematically illustrating a portion of the tool support device 1A of the first embodiment. FIG. 2 and FIG. 3 are schematic sectional views schematically illustrating a portion of the tool support device 1A of the first embodiment. FIG. 4 is a general sectional view schematically illustrating a portion of the tool support device 1A of a first modified example of the first embodiment. FIG. 5 is a general sectional view schematically illustrating a portion of the tool support device 1A of a second modified example of the first embodiment. Note that FIG. 2 and FIG. 4 illustrate a view in which a first lock mechanism 3 is in a locked state, and FIG. 3 and FIG. 5 illustrate a view in which the first lock mechanism 3 is in an unlocked state. FIG. 6 is a general perspective view schematically illustrating a portion of the tool support device 1A of the first embodiment. FIG. 7 is an arrow A-A sectional view in FIG. 2. FIG. 8 is a general sectional view schematically illustrating a portion of the tool support device 1A of the first embodiment. Note that FIG. 8 illustrates a view in which a receiving member 317 is located at a second position P2. FIG. 9 and FIG. 10 are schematic sectional views schematically illustrating a portion of the tool support device 1A of a third modified example of the first embodiment. Note that FIG. 9 illustrates a view in which the first lock mechanism 3 is in a locked state, and FIG. 10 illustrates a view in which the first lock mechanism 3 is in an unlocked state. FIG. 11 is an arrow B-B sectional view in FIG. 9. FIG. 12 is a general sectional view schematically illustrating a portion of the tool support device 1A of a fourth modified example of the first embodiment. FIG. 13 is a general perspective view schematically illustrating a portion of the tool support device 1A of a fifth modified example of the first embodiment. FIG. 14 and FIG. 15 are schematic sectional views schematically illustrating a portion of the tool support device 1A of a sixth modified example of the first embodiment. FIG. 16 and FIG. 17 are schematic sectional views schematically illustrating a portion of the tool support device 1A of a seventh modified example of the first embodiment. Note that FIG. 14 and FIG. 16 illustrate a view in which the first lock mechanism 3 is in a locked state, and FIG. 15 and FIG. 17 illustrate a view in which the first lock mechanism 3 is in an unlocked state. FIG. 18 is an arrow C-C sectional view in FIG. 16. FIG. 19 is an arrow D-D sectional view in FIG. 16.

As illustrated in FIG. 1 as an example, the tool support device 1A of the first embodiment includes a first arm member 2a and a second arm member 2b. The second arm member 2b is supported pivotably by the first arm member 2a. Each of the first arm member 2a and the second arm member 2b may be formed of a single component or may be formed of an assembly of a plurality of components.

As illustrated in FIG. 2 as an example, the tool support device 1A of the first embodiment includes a first lock mechanism 3 and a first unlocking member 4.

The first lock mechanism 3 locks pivoting of the second arm member 2b relative to the first arm member 2a by engagement between a plurality of engagement protruding parts 32 and a plurality of second engagement parts 34. The first lock mechanism 3 is formed of a plurality of components. Note that, in the present specification, “lock” encompasses not only complete lock but also substantial lock. In other words, in a locked state, due to the clearance between the members, it is permitted that the second arm member 2b is slightly pivotable with respect to the first arm member 2a.

As illustrated in FIG. 3 as an example, a first unlocking member 4 unlocks the pivoting of the second arm member 2b relative to the first arm member 2a locked by the first lock mechanism 3. The first unlocking member 4 may be formed of a single component or may be formed of a plurality of components.

As illustrated in FIG. 2 as an example, the first lock mechanism 3 has a pressing member 31, a pressed part 33, the plurality of engagement protruding parts 32, the plurality of second engagement parts 34, and a first pushing member 35.

As illustrated in FIG. 2 as an example, one of the first arm member 2a and the second arm member 2b is defined as a first member M1, and the other of the first arm member 2a and the second arm member 2b is defined as a second member M2.

The pressing member 31 presses the pressed part 33, and the pressed part 33 is pressed in a first direction DR1 by the pressing member 31. In the example illustrated in FIG. 2 and FIG. 3, the pressing member 31 is coupled to the second member M2 so as to be nonrotatable relative to and linearly movable relative to the second member M2. Further, the pressed part 33 is arranged in the first member M1. Note that, in the present specification, “nonrotatable relative to” encompasses not only being completely nonrotatable relative to an object of interest but also being substantially nonrotatable relative to an object of interest. In other words, relative rotation caused by play (clearance) between members is not regarded as substantial relative rotation.

An example in which the first arm member 2a is the first member M1 and the second arm member 2b is the second member M2 will be described below. In other words, an example in which the pressing member 31 is coupled to the second arm member 2b so as to be linearly movable relative to the second arm member 2b, and the pressed part 33 is arranged on the first arm member 2a will be described. In the embodiment, however, the first arm member 2a may be the second member M2, and the second arm member 2b may be the first member M1. In other words, as illustrated in FIG. 4 as an example, the pressing member 31 may be coupled to the first arm member 2a so as to be linearly movable relative to the first arm member 2a, and the pressed part 33 may be arranged to the second arm member 2b.

As illustrated in FIG. 2 as an example, the plurality of engagement protruding parts 32 are arranged on one (N1) of the pressing member 31 and the pressed part 33, and the plurality of second engagement parts 34 are arranged in the other (N2) of the pressing member 31 and the pressed part 33.

In the example illustrated in FIG. 3, the plurality of engagement protruding parts 32 are arranged on the pressed part 33, and the plurality of second engagement parts 34 are arranged in the pressing member 31. In the embodiment, however, the plurality of engagement protruding parts 32 may be arranged on the pressing member 31, and the plurality of the second engagement parts 34 may be arranged in the pressed part 33 (see FIG. 5 if necessary).

As illustrated in FIG. 2 as an example, the first pushing member 35 pushes the pressing member 31 in the first direction DR1 toward the pressed part 33. More specifically, the first pushing member 35 pushes the pressing member 31 in the first direction DR1 toward the pressed part 33 so as to maintain the engagement between the plurality of engagement protruding parts 32 and the plurality of second engagement parts 34.

As illustrated in FIG. 3 as an example, the first unlocking member 4 includes a first motion member 41 that moves the pressing member 31 in a second direction DR2 opposite to the first direction DR1 against the pushing force applied by the first pushing member 35.

The tool support device 1A of the first embodiment includes the first lock mechanism 3, and the first lock mechanism 3 has the pressing member 31, the pressed part 33, the plurality of engagement protruding parts 32 arranged on one (N1) of the pressing member 31 and the pressed part 33, the plurality of second engagement parts 34 arranged in the other (N2) of the pressing member 31 and the pressed part 33, and the first pushing member 35 that pushes the pressing member 31 in the first direction DR1 toward the pressed part 33. Thus, fixing of the angle of the second arm member 2b relative to the first arm member 2a can be effectively performed by the engagement between the plurality of engagement protruding parts 32 and the plurality of second engagement parts 34. More specifically, the fixing described above is effectively performed by both the pressing force of the first pushing member 35 pressing the pressing member 31 in the first direction DR1 and the engagement between the plurality of engagement protruding parts 32 and the plurality of second engagement parts 34. Further, since the force that maintains the fixing is distributed among the plurality of engagement protruding parts 32, only a small load is necessary that acts on each engagement protruding part 32. Thus, the durability of each engagement protruding part 32 is improved.

The tool support device 1A of the first embodiment includes the first unlocking member 4, and the first unlocking member 4 includes the first motion member 41 that moves the pressing member 31 in the second direction DR2 opposite to the first direction DR1. Thus, by using the first motion member 41 to move the pressing member 31 in the second direction DR2, it is possible to release the engagement between the plurality of engagement protruding parts 32 and the plurality of second engagement parts 34 (see FIG. 3). Such disengagement enables adjustment of the angle of the second arm member 2b relative to the first arm member 2a. Further, after the adjustment of the angle, the pushing force of the first pushing member 35 causes the plurality of engagement protruding parts 32 and the plurality of second engagement parts 34 to return from a disengaged state to an engaged state. Thus, the angle of the second arm member 2b relative to the first arm member 2a can be easily fixed at the adjusted angle.

In the example illustrated in FIG. 6, the tool support device 1A has a first joint part J1 for coupling the first arm member 2a and the second arm member 2b to each other in a pivotable manner, and the plurality of engagement protruding parts 32 described above (not illustrated in FIG. 6) and the plurality of second engagement parts 34 described above (not illustrated in FIG. 6) are arranged to the first joint part J1.

Further, in the example illustrated in FIG. 6, the tool support device 1A supports a gripping tool 110a. Alternatively, the tool support device 1A may support a tool other than gripping tools (for example, a cutting tool, a rotary tool, a stripping tool, a compression tool, a tool attached to a remote manipulation rod, or the like).

In the example illustrated in FIG. 6, the second arm member 2b supports a tool 110 via a second joint part J2 and a third arm member 2c (more specifically, via the second joint part J2 and the third arm member 2c that is a short arm). Alternatively, the third arm member 2c may be omitted, and the tool 110 may be attached to the second joint part J2. Further, alternatively, the third arm member 2c and the second joint part J2 may be omitted, and the tool 110 may be attached directly to the second arm member 2b.

Next, optional, additional configurations that can be employed in the tool support device 1A of the first embodiment (or a tool support device 1B of the second embodiment or a tool support device 1C of the third embodiment described later) will be described with reference to FIG. 1 to FIG. 19.

### First Axis Ax1

In the example illustrated in FIG. 2, the first arm member 2a supports the second arm member 2b so that the second arm member 2b is pivotable about the first axis AX1 parallel to the first direction DR1. Further, the engagement between a plurality of engagement protruding parts 32 and a plurality of second engagement parts 34 supports at least a part of the torque T about the first axis AX1 acting on the first arm member 2a from the second arm member 2b.

In the example illustrated in FIG. 2, at least a part of the torque T about the first axis AX1 acting on the first arm member 2a from the second arm member 2b is supported in a distributed manner by the plurality of engagement protruding parts 32. Thus, only a small load is necessary that acts on each engagement protruding part 32. As a result, durability of each engagement protruding part 32 is improved. Further, friction force between the plurality of engagement protruding part 32 and the plurality of second engagement parts 34 due to this torque T functions as resistive force when the pressing member 31 is moved in the second direction DR2. Thus, both the pushing force from the first pushing member 35 and the above resistive force prevent the pressing member 31 from being easily moved in the second direction DR2 (in other words, the unlocking direction). In such a way, unlocking manipulation not based on explicit intention of the operator is prevented. Note that the resistive force described above is the force based on friction force, and this resistive force effectively functions as static friction force before the pressing member 31 starts moving in the second direction DR2. Further, after the pressing member 31 started moving in the second direction DR2, the resistive force described above changes from static friction force to kinetic friction force. Thus, the resistive force described above does not serve as excessive resistive force after the pressing member 31 started moving in the second direction DR2.

In the example illustrated in FIG. 2, a part of the torque T about the first axis AX1 acting on the first arm member 2a from the second arm member 2b is supported by friction force between the surface 312 on the first direction DR1 side of the pressing member 31 and the surface 330 on the second direction DR2 side of the pressed part 33. When a part of the torque T described above is supported by the friction force between the surface 312 on the first direction DR1 side of the pressing member 31 and the surface 330 on the second direction DR2 side of the pressed part 33, only a smaller load is necessary that acts on each engagement protruding part 32.

Pressing member 31

In the example illustrated in FIG. 3, the pressing member 31 has a pressing plate part 311 and a first shaft 315.

The pressing plate part 311 is a portion that presses the pressed part 33. In the example illustrated in FIG. 3, the pressing plate part 311 extends along a plane perpendicular to the first axis AX1.

The first shaft 315 supports the pressing plate part 311. In the example illustrated in FIG. 3, the pressing member 31 includes the first shaft 315, and the second member M2 (more specifically, the second arm member 2b) includes the second shaft 215. Each of the first shaft 315 and the second shaft 215 extends in the first axis AX1.

The first shaft 315 is coupled to the second shaft 215 so as to be nonrotatable relative to the second shaft 215 about the first axis AX1 and movable relative to the second shaft 215 in a direction parallel to the first axis AX1.

It is preferable that one of the first shaft 315 and the second shaft 215 have a hollow portion 316 that receives a part of the other of the first shaft 315 and the second shaft 215. In the example illustrated in FIG. 3, the first shaft 315 has the hollow portion 316, and the hollow portion 316 defines a receiving space SP that receives an end 216 of the second shaft 215.

In the example illustrated in FIG. 7, the end 216 of the second shaft 215 has a non-circular shape (for example, a hexagonal shape) in a cross section perpendicular to the first axis AX1. Further, the receiving space SP defined by the hollow portion 316 has a non-circular shape (for example, a hexagonal shape) complementary to the non-circular shape described above of the end 216 of the second shaft 215 in the cross section perpendicular to the first axis AX1. With these non-circular shapes, relative rotation of the first shaft 315 with respect to the second shaft 215 is inhibited, and linear motion of the first shaft 315 with respect to the second shaft 215 is allowed. Note that, as the shape that inhibits relative rotation and allows linear motion, other polygonal shapes than the hexagonal shape, keyhole shapes, elliptical shapes, or spline shapes may be employed.

In the example illustrated in FIG. 2, the pressing member 31 has a receiving member 317 that receives acting force from the first unlocking member 4 (more specifically, the first motion member 41). The receiving member 317 receives, from the first unlocking member 4, acting force having a force component in a direction along the second direction DR2, and thereby the pressing member 31 including the receiving member 317 moves in the second direction DR2 (see FIG. 3). As a result, the pivoting of the second arm member 2b relative to the first arm member 2a locked by the first lock mechanism 3 is unlocked.

As illustrated in FIG. 2 and FIG. 8 as examples, repositioning of the receiving member 317 may be possible between a first position P1 that enables motion of the first motion member 41 to be converted into unlocking of pivoting described above (see FIG. 2) and a second position P2 that disables motion of the first motion member 41 to be converted into unlocking of pivoting described above (see FIG. 8). In a state where the receiving member 317 is located at the second position P2, the locking of pivoting of the second arm member 2b with respect to the first arm member 2a is maintained regardless of the position of the first motion member 41. This prevents unintended unlocking of the pivoting.

The receiving member 317 may be fixed by being screwed onto the first shaft 315. In such a case, it is possible to reposition the receiving member 317 between the first position P1 and the second position P2 by pivoting the receiving member 317 about the first shaft 315.

[Multiple engagement protruding parts 32] As illustrated in FIG. 3 as an example, a plurality of engagement protruding parts 32 including the first engagement protruding part 32-1 and the second engagement protruding part 32-2 are arranged on one (N1) of the pressing member 31 and the pressed part 33. The number of engagement protruding parts 32 arranged on one (N1) of the pressing member 31 and the pressed part 33 may be 6 or greater, may be 12 or greater, may be 24 or greater, or may be 36 or greater. Note that, as the number of the engagement protruding parts 32 increases, the load acting on each engagement protruding part 32 decreases.

In the example illustrated in FIG. 3, the plurality of engagement protruding parts 32 include a plurality of engagement pins 321. As illustrated in FIG. 7 as an example, the plurality of engagement pins 321 may be arranged at equal angular intervals about the first axis AX1.

Alternatively, as illustrated in FIG. 9 as an example, the plurality of engagement protruding parts 32 may include a plurality of engagement protrusions 323. As illustrated in FIG. 11 as an example, the plurality of engagement protrusions 323 may be arranged at equal angular intervals about the first axis AX1.

In the example illustrated in FIG. 7 or FIG. 11, the plurality of engagement protruding parts 32 are arranged regularly about the first axis AX1. Alternatively, as illustrated in FIG. 12 as an example, the plurality of engagement protruding parts 32 may be arranged irregularly about the first axis AX1.

### Multiple Second Engagement Parts 34

In the example illustrated in FIG. 3, a plurality of second engagement parts 34 are arranged in the other (N2) of the pressing member 31 and the pressed part 33. The plurality of second engagement parts 34 can receive a plurality of engagement protruding parts 32 including the first engagement protruding part 32-1 and the second engagement protruding part 32-2. The number of second engagement parts 34 may be 6 or greater, may be 12 or greater, may be 24 or greater, or may be 36 or greater.

The plurality of second engagement parts 34 may include a plurality of engagement holes 341 that receive the plurality of engagement protruding parts 32 (see FIG. 2) or may include a plurality of engagement recesses 343 that receive the plurality of engagement protruding parts 32 (see FIG. 9). Note that each engagement recess may be an engagement groove or may be a recess in a form other than the engagement groove.

As illustrated in FIG. 7 or FIG. 11 as an example, the plurality of second engagement parts 34 (more specifically, a plurality of engagement holes 341 or a plurality of engagement recesses 343) may be arranged at equal angular intervals about the first axis AX1.

When a plurality of second engagement parts 34 are arranged at equal angular intervals about the first axis AX1, the angle of the second arm member 2b relative to the first arm member 2a can be adjusted on a predetermined angle basis. In the example illustrated in FIG. 7 or FIG. 11, the plurality of second engagement parts 34 are arranged at equal angular intervals over an angular region of 360 degrees (in other words, over an annular region) about the first axis AX1. When the movable angle of the second arm member 2b may be smaller or the like, however, the plurality of second engagement parts 34 may be arranged at equal angular intervals over an angular region smaller than 360 degrees (in other words, over a circular arc-shaped region) about the first axis AX1. Note that, due to the presence of play (in other words, clearance) between the members, the operator is able to more finely adjust the angle of the second arm member 2b relative to the first arm member 2a adjusted on an angle basis described above.

As illustrated in FIG. 7 or FIG. 11 as an example, it is preferable that the plurality of second engagement parts 34 be arranged in the outer circumferential edge region of the other (N2) of the pressing member 31 and the pressed part 33. When the plurality of second engagement parts 34 are arranged in the outer circumferential edge region, the size of each second engagement part 34 can be relatively larger, and the size of the engagement protruding part 32 received by each second engagement part 34 can be relatively larger. Thus, the strength of each engagement protruding part 32 is improved.

In the example illustrated in FIG. 3, the plurality of second engagement parts 34 include a plurality of engagement holes 341 that can be engaged with the plurality of engagement protruding parts 32. Each engagement hole 341 extends in a direction parallel to the first axis AX1. In the example illustrated in FIG. 3, each engagement hole 341 is a bottomless through hole. Alternatively, each engagement hole 341 may be a bottomed hole.

Alternatively, in the example illustrated in FIG. 10, the plurality of second engagement parts 34 include a plurality of engagement recesses 343 (more specifically, the plurality of engagement grooves 344) that can be engaged with the plurality of engagement protruding parts 32 (more specifically, the plurality of engagement protrusions 323).

In the example illustrated in FIG. 11, each of the plurality of engagement grooves 344 is a groove extending in a direction perpendicular to the first axis AX1 (more specifically, the radial direction perpendicular to the first axis AX1). In the example illustrated in FIG. 10, each of the plurality of engagement grooves 344 is formed in the surface 312 on the first direction DR1 side of the pressing member 31, and each of the plurality of the engagement protruding parts 32 is arranged on the pressed part 33. Alternatively, each of the plurality of engagement grooves 344 may be formed in the surface 330 on the second direction DR2 side of the pressed part 33, and each of the plurality of engagement protruding parts 32 may be arranged on the pressing member 31.

Further alternatively, as illustrated in FIG. 13 as an example, the plurality of second engagement parts 34 (more specifically, the plurality of engagement recesses 343) may be formed in the outer circumferential face N2s of the other (N2) of the pressing member 31 and the pressed part 33. In the example illustrated in FIG. 13, the plurality of second engagement parts 34 are the plurality of engagement grooves 344 formed in the outer circumferential face 313 of the pressing member 31. In the example illustrated in FIG. 13, each of the plurality of engagement grooves 344 extends in a direction parallel to the first axis AX1.

Further, in the example illustrated in FIG. 13, the plurality of engagement protruding parts 32 (more specifically, the plurality of engagement pins 321) arranged on the pressed part 33 (not illustrated in FIG. 13) are engaged with the plurality of engagement grooves 344.

When the engagement groove 344 is formed in the outer circumferential face 313, the size of the engagement groove 344 can be relatively larger, and the engagement pin 321 received in this engagement groove 344 can be relatively larger. Thus, the strength of each engagement pins 321 is improved.

As illustrated in FIG. 2, FIG. 9, FIG. 13, and the like as examples, pivoting of the second arm member 2b relative to the first arm member 2a is locked in a state where the plurality of engagement holes 341 or the plurality of engagement recesses 343 have received the plurality of engagement protruding parts 32. In contrast, as illustrated in FIG. 3, FIG. 10, and the like as examples, the pivoting of the second arm member 2b relative to the first arm member 2a is unlocked in a state where the plurality of engagement protruding parts 32 are detached from the plurality of engagement holes 341 or the plurality of engagement recesses 343.

In the example illustrated in FIG. 7 and FIG. 11, the number of engagement protruding parts 32 matches the number of second engagement parts 34 (more specifically, the number of engagement protruding parts 32 is 36, and the number of second engagement parts 34 is 36). Alternatively, the number of engagement protruding parts 32 may differ from the number of second engagement parts 34. More specifically, the number of engagement protruding parts 32 may be less than the number of second engagement parts 34. In such a case, at least one second engagement part 34 is in a free state where the at least one second engagement part 34 is not engaged with any of the engagement protruding part 32 in a state where the plurality of engagement protruding parts 32 are engaged with the plurality of second engagement parts 34.

### First Friction Plate 16

As illustrated in FIG. 14 as an example, the tool support device 1A may have the first friction plate 16. In the example illustrated in FIG. 14 and FIG. 15, the first friction plate 16 is coupled to a first member M1 (in the example illustrated in FIG. 14, the first member M1 is the first arm member 2a) so as to be nonrotatable relative to and linearly movable relative to the first member M1. It is preferable for the first member M1 (for example, the first arm member 2a) to have a first guide part 26 that guides motion of the first friction plate 16 in a direction parallel to the first axis AX1.

In the example illustrated in FIG. 14, the first pushing member 35 presses the pressing member 31 in the first direction DR1 via the first friction plate 16. As a result, the plurality of engagement protruding parts 32 arranged on one (N1) of the pressing member 31 and the pressed part 33 are engaged with the plurality of second engagement parts 34 arranged in the other (N2) of the pressing member 31 and the pressed part 33. In such a way, pivoting of the second arm member 2b relative to the first arm member 2a is locked.

In the state illustrated in FIG. 14, it is assumed that the first motion member 41 moves the pressing member 31 in the second direction DR2. In such a case, as illustrated in FIG. 15 as an example, the pressing member 31 and the first friction plate 16 are moved in the second direction DR2 against the pushing force of the first pushing member 35. As a result, the engagement between the plurality of engagement protruding parts 32 and the plurality of second engagement parts 34 is released, and the pivoting of the second arm member 2b relative to the first arm member 2a is unlocked. Note that, in the example illustrated in FIG. 15, the pressing member 31 (more specifically, the pressing plate part 311) and the first friction plate 16 are in firm contact with each other by the pushing force of the first pushing member 35. Thus, the first friction plate 16 is prevented from being rotated at a high speed about the first axis AX1 relative to the pressing member 31.

When the tool support device 1A has the first friction plate 16 that is nonrotatable relative to and linearly movable relative to the first member M1, the second arm member 2b is prevented from being pivoted with respect to the first arm member 2a at a high speed in a state where the engagement between the plurality of engagement protruding parts 32 and the plurality of second engagement parts 34 have been released. In other words, the first friction plate 16 applies high resistive force against relative rotation of the second arm member 2b relative to the first arm member 2a. For example, in the example illustrated in FIG. 15, high resistive force against relative rotation of the second arm member 2b relative to the first arm member 2a is applied by friction between the first friction plate 16 and the pressing plate part 311. Note that the resistive force may be set to such force that does not cause relative rotation of the second arm member 2b relative to the first arm member 2a unless the operator applies force to the second arm member 2b or may be set to such force that causes low speed relative rotation of the second arm member 2b relative to the first arm member 2a even in a state where the operator does not apply any force to the second arm member 2b.

As discussed above, when the tool support device 1A has the first friction plate 16, the second arm member 2b is prevented from being pivoted at a high speed relative to the first arm member 2a, and safety of the operator is ensured. For example, it is assumed that the second arm member 2b of the tool support device 1A supports a heavy tool directly or via another member. In such a case, the second arm member 2b is not pivoted at a high speed even when locking applied by the first lock mechanism 3 is released in a state where the operator has released its hand from the second arm member 2b. Thus, safety of the operator is ensured.

Note that, since the first friction plate 16 is movable in a direction parallel to the first axis AX1 together with the pressing member 31 in response to the pushing force from the first pushing member 35, movement of the first lock mechanism 3 and the first unlocking member 4 is not obstructed by the presence of the first friction plate 16.

### Second Friction Plate 17

In the example illustrated in FIG. 16, the tool support device 1A has, in addition to the first friction plate 16, a second friction plate 17 in contact with the first friction plate 16.

The first friction plate 16 is rotatable about the first axis AX1 relative to the pressing member 31 and nonrotatable about the first axis AX1 relative to the pressed part 33. Further, as illustrated in FIG. 16 and FIG. 17 as an example, the first friction plate 16 is movable in a direction parallel to the first axis AX1 relative to the pressed part 33. More specifically, the first friction plate 16 is coupled to the first member M1 (more specifically, the first arm member 2a) so as to be movable in a direction parallel to the first axis AX1 relative to the pressed part 33. As illustrated in FIG. 18 as an example, it is preferable for the first member M1 (for example, the first arm member 2a) to have a first guide part 26 that guides motion of the first friction plate 16 in a direction parallel to the first axis AX1. In the example illustrated in FIG. 18, the first guide part 26 has a spline shape in a cross section perpendicular to the first axis AX1. Alternatively, the first guide part 26 may have a polygonal shape, an elliptical shape, or a keyhole shape in a cross section perpendicular to the first axis AX1. In other words, the sectional shape of the first guide part 26 in the cross section perpendicular to the first axis AX1 may be any shape as long as it prevents pivoting of the first friction plate 16 about the first axis AX1 and allows motion of the first friction plate 16 in a direction parallel to the first axis AX1.

In the example illustrated in FIG. 16, the second friction plate 17 is rotatable about the first axis AX1 relative to the pressed part 33 and nonrotatable about the first axis AX1 relative to the pressing member 31. As illustrated in FIG. 16 and FIG. 17 as an example, the second friction plate 17 is movable in a direction parallel to the first axis AX1 relative to the pressed part 33. More specifically, the second friction plate 17 is coupled to the pressing member 31 (more specifically, the first shaft 315 of the pressing member 31) so as to be movable in a direction parallel to the first axis AX1 relative to the pressed part 33. As illustrated in FIG. 19 as an example, it is preferable for the pressing member 31 (more specifically, the first shaft 315) to have a second guide part 36 that allows the second friction plate 17 to move in a direction parallel to the first axis AX1 with respect to the pressing member 31. In the example illustrated in FIG. 19, the second guide part 36 has a spline shape in a cross section perpendicular to the first axis AX1. Alternatively, the second guide part 36 may have a polygonal shape, an elliptical shape, or a key shape in a cross section perpendicular to the first axis AX1. In other words, the sectional shape of the second guide part 36 in the cross section perpendicular to the first axis AX1 may be any shape as long as it prevents pivoting of the second friction plate 17 about the first axis AX1 and allows motion of the second friction plate 17 in a direction parallel to the first axis AX1 with respect to the pressing member 31.

Note that it is sufficient that the second friction plate 17 is slightly movable in a direction parallel to the first axis AX1 relative to the pressing member 31 so that pressing force in the first direction DR1 from the second friction plate 17 to the first friction plate 16 is transferred (for example, the length of the second guide part 36 in the direction parallel to the first axis AX1 may be short in FIG. 16).

In the example illustrated in FIG. 16, the first pushing member 35 presses the pressing member 31 in the first direction DR1 via the first friction plate 16 and the second friction plate 17. As a result, the plurality of engagement protruding parts 32 arranged on one (N1) of the pressing member 31 and the pressed part 33 are engaged with the plurality of second engagement parts 34 arranged in the other (N2) of the pressing member 31 and the pressed part 33. In such a way, pivoting of the second arm member 2b relative to the first arm member 2a is locked.

In a state illustrated in FIG. 16, it is assumed that the first motion member 41 moves the pressing member 31 in the second direction DR2. In such a case, as illustrated in FIG. 17 as an example, the pressing member 31, the first friction plate 16, and the second friction plate 17 moves in the second direction DR2 against the pushing force of the first pushing member 35. As a result, the engagement between the plurality of engagement protruding parts 32 and the plurality of second engagement parts 34 is released, and the pivoting of the second arm member 2b relative to the first arm member 2a is unlocked. Note that, in the example illustrated in FIG. 17, the first friction plate 16 and the second friction plate 17 are in firm contact with each other by the pushing force of the first pushing member 35. Thus, the first friction plate 16 is prevented from being rotated at a high speed about the first axis AX1 relative to the second friction plate 17. The first friction plate 16 is nonrotatable about the first axis AX1 relative to the pressed part 33, and the second friction plate 17 is nonrotatable about the first axis AX1 relative to the pressing member 31. Thus, because the first friction plate 16 is not rotated at a high speed relative to the second friction plate 17, the second arm member 2b is also prevented from being pivoted at a high speed relative to the first arm member 2a.

As discussed above, when the tool support device 1A has the first friction plate 16, which is nonrotatable relative to the pressed part 33, and the second friction plate 17, which is nonrotatable relative to the pressing member 31, the second arm member 2b is prevented from being pivoted at a high speed relative to the first arm member 2a in a state where the engagement between the plurality of engagement protruding parts 32 and the plurality of second engagement parts 34 has been released. In other words, the friction force acting between the first friction plate 16 and the second friction plate 17 applies high resistive force against relative rotation of the second arm member 2b relative to the first arm member 2a. Note that this resistive force may be set to such force that does not cause relative rotation of the second arm member 2b relative to the first arm member 2a unless the operator applies force to the second arm member 2b or may be set to such force that causes low speed relative rotation of the second arm member 2b relative to the first arm member 2a even in a state where the operator does not apply any force to the second arm member 2b.

The number of first friction plates 16 described above may be one or may be plural. Further, the number of second friction plates 17 described above may be one or may be plural. Note that the greater the number of first friction plates 16 and second friction plates 17 is, the larger the resistive force described above will be. In the example illustrated in FIG. 16, the first friction plate 161 is held between the second friction plate 171 and the pressing member 31. Additionally, the second friction plate 171 may be held between one first friction plate 161 and another first friction plate 162. Further additionally, such another first friction plate 162 may be held between one second friction plate 171 and another second friction plate 172.

In the example illustrated in FIG. 16, the number of first friction plates 16 is three. Alternatively, the number of first friction plates 16 may be one, two, or four or greater. Further, in the example illustrated in FIG. 16, the number of second friction plates 17 is two. Alternatively, the number of second friction plates 17 may be one or three or greater.

First pushing Member 35

In the example illustrated in FIG. 16 and the like, the first pushing member 35 pushes the pressing member 31 in the first direction DR1 toward the pressed part 33. For example, the first pushing member 35 is a spring member 351 (more specifically, a coil spring). In the example illustrated in FIG. 16 and the like, the spring member 351 is arranged so as to surround the pressing member 31 (more specifically, the first shaft 315 of the pressing member 31). More specifically, the spring member 351 is arranged coaxially with the first shaft 315.

### First Housing 37

In the example illustrated in FIG. 17 and the like, the first member M1 (more specifically, the first arm member 2a) has a first housing 37 accommodating the first pushing member 35 and the pressing plate part 311 of the pressing member 31. The first housing 37 may accommodate at least one first friction plate 16 or may accommodate at least one second friction plate 17.

In the example illustrated in FIG. 17, the first housing 37 has an end plate 371. A through hole 372 through which a part of the pressing member 31 (more specifically, the first shaft 315) is inserted may be formed in the end plate 371. In the example illustrated in FIG. 17, one part of the first shaft 315 is arranged inside the first housing 37, and another part of the first shaft 315 is arranged outside the first housing 37.

In the example illustrated in FIG. 15 or FIG. 17, at least one first friction plate 16 and/or at least one second friction plate 17 is arranged between the end plate 371 of the first housing 37 and the pressing plate part 311. In the example illustrated in FIG. 15 or FIG. 17, the first guide part 26 that guides the first friction plate 16 is formed to a side wall 373 (more specifically, inside the side wall 373) of the first housing 37.

### Second Pushing Member 45

In the example illustrated in FIG. 16 and the like, the tool support device 1A includes a second pushing member 45 that pushes the pressing member 31 in the second direction DR2. The second pushing force of the second pushing member 45 is smaller than the pushing of from the first pushing member 35. Thus, the pressing member 31 that receives the pushing force in the first direction DR1 from the first pushing member 35 and receives the second pushing force in the second direction DR2 from the second pushing member 45 presses the pressed part 33 in a default state.

In the example illustrated in FIG. 16 and the like, it is assumed that the first motion member 41 moves the pressing member 31 in the second direction DR2. In such a case, as illustrated in FIG. 17 and the like as an example, the pressing member 31 moves in the second direction DR2 against the pushing force of the first pushing member 35. The second pushing member 45 assists the motion of the pressing member 31 in the second direction DR2. This assist suppresses the pressing member 31 from tilting relative to the first axis AX1 when the pressing member 31 is moved in the second direction DR2. In particular, in the example illustrated in FIG. 16 and the like, due to the torque T about the first axis AX1 acting on the first arm member 2a from the second arm member 2b, friction force occurs between the side face of the engagement protruding part 32 and the side face of the second engagement part 34. Due to this friction force, the pressing member 31 is likely to tilt relative to the first axis AX1 when the pressing member 31 is moved in the second direction DR2. The second pushing member 45 suppresses tilting of the pressing member 31 by assisting the motion in the second direction DR2 of the pressing member 31.

As discussed above, the pressing member 31 is smoothly moved in the second direction DR2 by the acting force of the first motion member 41 and assistance from the second pushing member 45. Further, as a result of the smooth motion in the second direction DR2 of the pressing member 31, the pivoting of the second arm member 2b relative to the first arm member 2a is smoothly unlocked.

For example, the second pushing member 45 is a spring member 451 (more specifically, a coil spring). In the example illustrated in FIG. 16 and the like, a part of the spring member 451 is arranged in an annular recess 46 formed in the first member M1 (more specifically, the first arm member 2a).

In the example illustrated in FIG. 16, the second pushing member 45 is arranged between a bottom wall 461 of the annular recess 46 and the pressing member 31 (more specifically, the pressing plate part 311).

### First Wire W1

In the example illustrated in FIG. 16 and the like, the tool support device 1A includes a first wire W1 for manipulating the first unlocking member 4 (more specifically, the first motion member 41).

In the example illustrated in FIG. 16 and the like, when the first wire W1 is pulled so that the tension of the first wire W1 is increased, the first wire W1 manipulates the first motion member 41, and the first motion member 41 manipulated by the first wire W1 moves the pressing member 31 in the second direction DR2. In such a way, pivoting of the second arm member 2b relative to the first arm member 2a is unlocked. In this unlocked state, the operator can change a relative angle about the first axis AX1 of the second arm member 2b relative to the first arm member 2a.

In contrast, in the example illustrated in FIG. 17 and the like, when the first wire W1 is loosened, the pressing member 31 is moved in the first direction DR1 by the pushing force of the first pushing member 35. In such a way, pivoting of the second arm member 2b relative to the first arm member 2a is locked again.

In the example illustrated in FIG. 16 and FIG. 17, the tool support device 1A includes the first motion member 41 configured to move the pressing member 31 in the second direction DR2 against the pushing force applied by the first pushing member 35 and the first wire W1 for manipulating the first motion member 41. It is therefore possible to unlock the pivoting of the second arm member 2b relative to the first arm member 2a by pulling the first wire W1. Further, it is possible to lock the pivoting of the second arm member 2b relative to the first arm member 2a by loosening the first wire W1.

In the example illustrated in FIG. 17, the pressing member 31 has a receiving member 317 that receives acting force from the first motion member 41. The receiving member 317 can be repositioned between a first position P1 that enables transfer of the manipulation of the first wire W1 to the pressing member 31 and a second position P2 that disables transfer of the manipulation of the first wire W1 to the pressing member 31. More specifically, when the receiving member 317 is located at the first position P1, the first motion member 41 is able to transfer pulling force received from the first wire W1 to the receiving member 317 of the pressing member 31. In contrast, when the receiving member 317 is located at the second position P2, the first motion member 41 is unable to transfer pulling force received from the first wire W1 to the receiving member 317 of the pressing member 31.

### First Unlocking Member 4

In the example illustrated in FIG. 16 and the like, the first unlocking member 4 has a first motion member 41 and a support member 43 that supports the first motion member 41 in a pivotable manner. In the example illustrated in FIG. 16, the support member 43 is attached to the first member M1 (more specifically, the first arm member 2a).

In the example illustrated in FIG. 16 and the like, the first motion member 41 has a first end 411 that is pulled by the first wire W1 and a second end 412 that can press the pressing member 31 (more specifically, the receiving member 317 of the pressing member 31). In the example illustrated in FIG. 16, the first motion member 41 is a leverage member having a fulcrum, a point of effort, and a point of action. More specifically, the fulcrum is formed of a portion in contact with the support member 43, the point of effort is formed of the first end 411 connected to the first wire W1, and the point of action is formed of the second end 412 that presses the pressing member 31.

In the example illustrated in FIG. 16 and the like, when the first wire W1 is pulled so that the tension of the first wire W1 is increased, the first wire W1 pulls the first end 411 of the first motion member 41. When the first end 411 is pulled, the first motion member 41 is pivoted about the contact portion with the support member 43 as the fulcrum. The second end 412 of the first motion member 41 pivoting about the fulcrum presses the pressing member 31 in the second direction DR2. As a result, the pressing member 31 is moved in the second direction DR2, and the pivoting of the second arm member 2b relative to the first arm member 2a is unlocked.

In the example illustrated in FIG. 16 and the like, the first motion member 41 is manipulated by using the tension of the first wire W1. Alternatively, the first motion member 41 may be manipulated by using hydraulic pressure.

### Second Embodiment

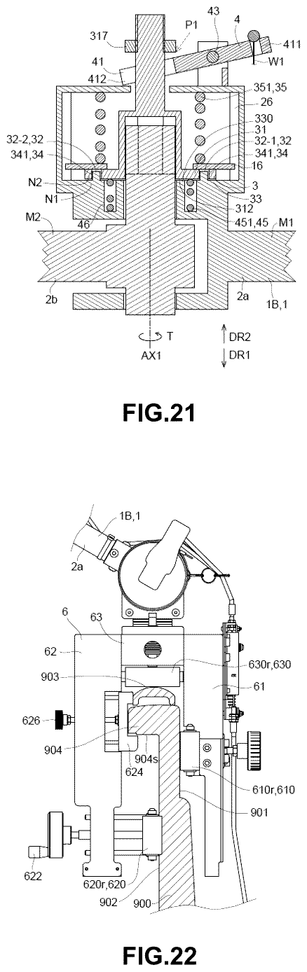

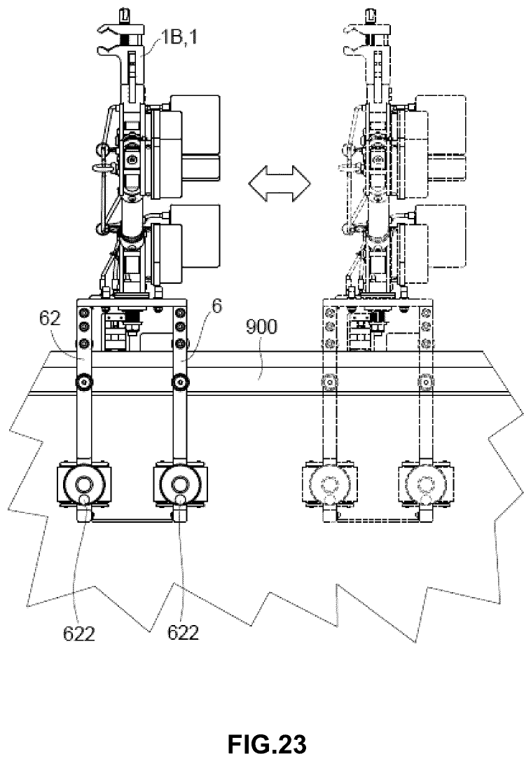

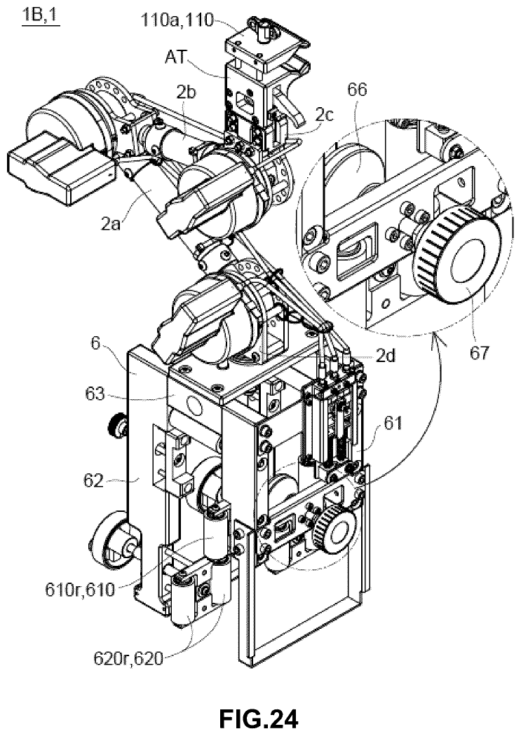

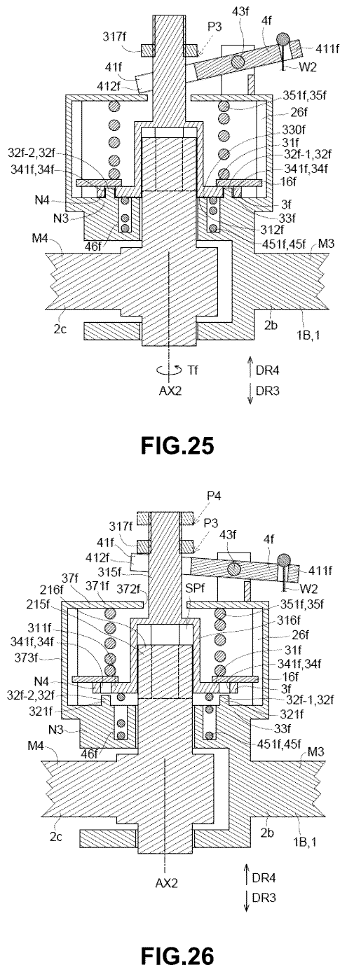

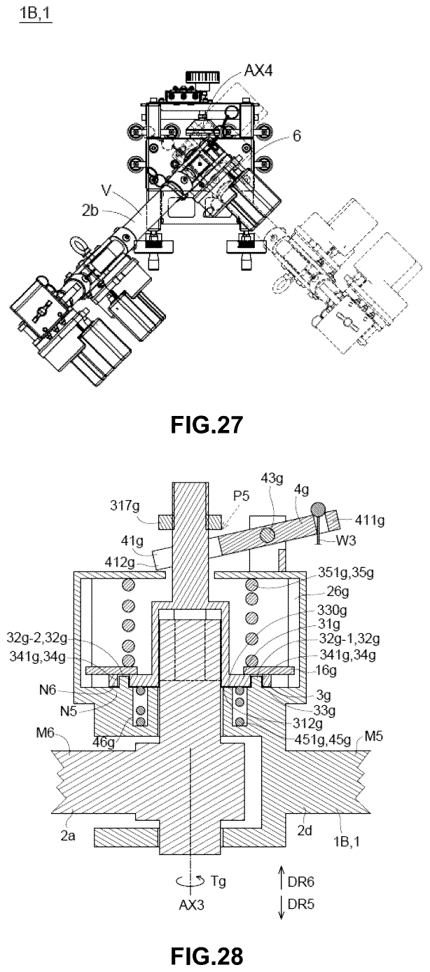

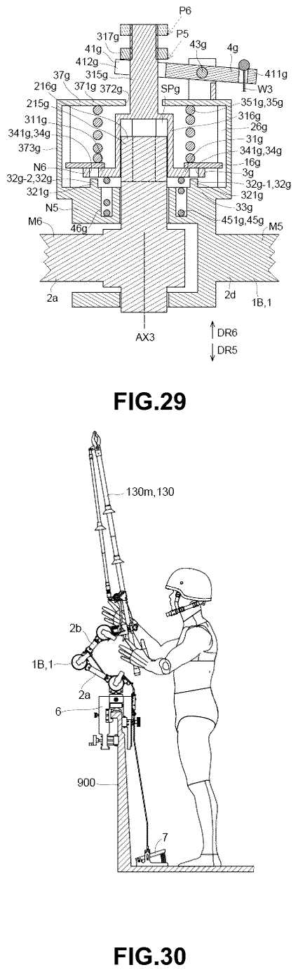

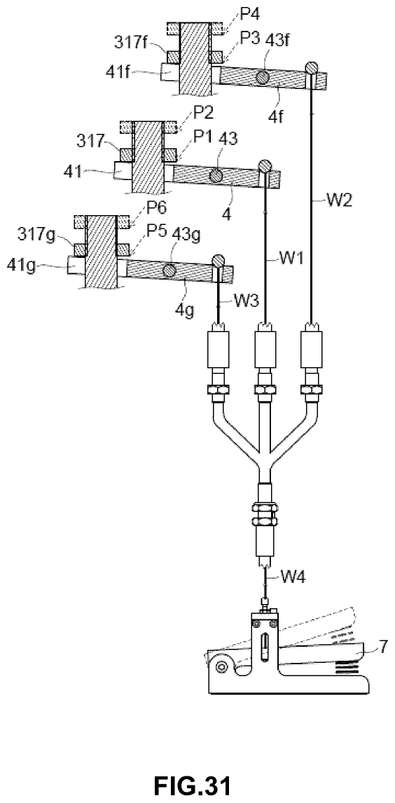

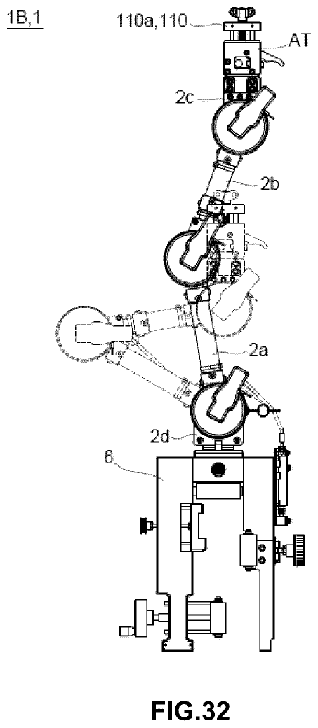

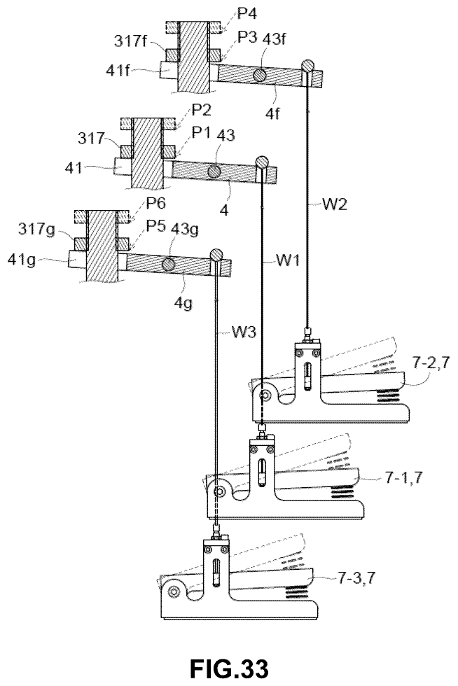

A tool support device 1B of a second embodiment will be described with reference to FIG. 1 to FIG. 33. FIG. 20 is a general two-side view schematically illustrating the tool support device 1B of the second embodiment. Note that a general side view is illustrated on the left side in FIG. 20, and a general front view is illustrated on the right side in FIG. 20. FIG. 21 is a general sectional view schematically illustrating a portion of the tool support device 1B of the second embodiment. FIG. 22 is a general side view schematically illustrating a portion of the tool support device 1B of the second embodiment. FIG. 23 is a diagram schematically illustrating a view in which the entire base unit 6 of the tool support device 1B is slidably movable with respect to a bucket 900. FIG. 24 is a general perspective view schematically illustrating the tool support device 1B of the second embodiment. FIG. 25 and FIG. 26 are general sectional views schematically illustrating a portion of the tool support device 1B of the second embodiment. Note that FIG. 25 illustrates a view in which a second lock mechanism 3f is in a locked state, and FIG. 26 illustrates a view in which the second lock mechanism 3f is in an unlocked state. FIG. 27 is a general plan view schematically illustrating the tool support device 1B of the second embodiment. FIG. 28 and FIG. 29 are general sectional views schematically illustrating a portion of the tool support device 1B of the second embodiment. Note that FIG. 28 illustrates a view in which a third lock mechanism 3g is in a locked state, and FIG. 29 illustrates a view in which the third lock mechanism 3g is in an unlocked state. FIG. 30 is a diagram schematically illustrating a view in which the tool support device 1B has a foot pedal 7. FIG. 31 is a diagram schematically illustrating a view in which a plurality of unlocking members (4, 4f, 4g) are collectively manipulated by a single foot pedal 7. FIG. 32 is a general side view schematically illustrating the tool support device 1B of the second embodiment. FIG. 33 is a diagram schematically illustrating a view in which a plurality of unlocking members (4, 4f, 4g) are manipulated by a plurality of foot pedals 7, respectively.

In the second embodiment, features different from the first embodiment will be mainly described, and duplicated description for features that have already been described in the first embodiment will be omitted. It is therefore obvious that, even when not explicitly described in the second embodiment, the features that have already been described in the first embodiment can be employed in the second embodiment.

As illustrated in FIG. 20 as an example, the tool support device 1B of the second embodiment includes (1) the first arm member 2a and (2) the second arm member 2b supported pivotably by the first arm member 2a. Further, as illustrated in FIG. 21 as an example, the tool support device 1B of the second embodiment includes (3) the first lock mechanism 3 that locks pivoting of the second arm member 2b relative to the first arm member 2a by engagement between the plurality of engagement protruding parts 32 and the plurality of second engagement parts 34 and (4) the first unlocking member 4 that unlocks the pivoting of the second arm member 2b relative to the first arm member 2a locked by the first lock mechanism 3. Further, as illustrated in FIG. 21 as an example, the first lock mechanism 3 has (5) when one of the first arm member 2a and the second arm member 2b is defined as the first member M1 and the other of the first arm member 2a and the second arm member 2b is defined as the second member M2, the pressing member 31 coupled to the second member M2 so as to be nonrotatable relative to and linearly movable relative to the second member M2, (6) the pressed part 33 arranged in the first member M1 and pressed by the pressing member 31, (7) the plurality of engagement protruding parts 32 arranged on one (N1) of the pressing member 31 and the pressed part 33, (8) the plurality of second engagement parts 34 arranged in the other (N2) of the pressing member 31 and the pressed part 33, and (9) the first pushing member 35 that pushes the pressing member 31 in the first direction DR1 toward the pressed part 33 so that the engagement between the plurality of engagement protruding parts 32 and the plurality of second engagement parts 34 is maintained. Further, the first unlocking member 4 includes (10) the first motion member 41 that moves the pressing member 31 in the second direction DR2 opposite to the first direction DR1 against the pushing force applied by the first pushing member 35.

Thus, the second embodiment achieves the same advantageous effects as the first embodiment.

Note that it is obvious that, as the configurations related to the first lock mechanism 3 and the first unlocking member 4, (A) the configuration illustrated in FIG. 2, FIG. 3, FIG. 7, and FIG. 8, (B) the configuration illustrated in FIG. 4, (C) the configuration illustrated in FIG. 5, (D) the configuration illustrated in FIG. 9 to FIG. 11, (E) the configuration illustrated in FIG. 12, (F) the configuration illustrated in FIG. 13, (G) the configuration illustrated in FIG. 14 and FIG. 15, or (H) the configuration illustrated in FIG. 16 to FIG. 19 may be employed in the second embodiment.

Next, optional, additional configurations that can be employed in the tool support device 1B of the second embodiment will be described with reference to FIG. 1 to FIG. 33.

### Base Unit 6

In the example illustrated in FIG. 22, the tool support device 1B includes the base unit 6 that can be attached directly to the bucket 900 of an aerial work platform.

In the example illustrated in FIG. 22, the base unit 6 has an inner member 61 arranged inside the bucket 900, an outer member 62 arranged outside the bucket 900, and an upper member 63 arranged above a top edge 904 of the bucket 900. The inner member 61, the outer member 62, and the upper member 63 are coupled to each other in side view so as to form an inverse U-shape.

In the example illustrated in FIG. 23, the entire base unit 6 is configured to be slidably movable with respect to the bucket 900 with the base unit 6 being directly attached to the bucket 900. In such a case, the entire tool support device 1B can be made compact compared to a case where a rail member is attached to the bucket 900 and the base unit of the tool support device is attached to the rail member. In other words, since the rail member is omitted, and the bucket 900 itself functions as a rail member, the entire tool support device 1B can be made compact. Further, since the base unit 6 is directly attached to the bucket 900, the man-hour of the operation to attach the tool support device 1B to the bucket 900 is reduced.

An example of the configuration in which the entire base unit 6 is slidably movable with respect to the bucket 900 will be described in more detail.

In the example illustrated in FIG. 22, the base unit 6 has a first lateral motion member 610, a second lateral motion member 620, and a third lateral motion member 630. More specifically, the inner member 61 of the base unit 6 has the first lateral motion member 610, the outer member 62 of the base unit 6 has the second lateral motion member 620, and the upper member 63 of the base unit 6 has the third lateral motion member 630.

The first lateral motion member 610 is a member movable in the lateral direction along an inner side face 901 of the bucket 900 while being in contact with the inner side face 901. In the example illustrated in FIG. 22, the first lateral motion member 610 includes at least one first roller 610r rolling on the inner side face 901 of the bucket 900. Alternatively or additionally, the first lateral motion member 610 may include at least one first slider that slides on the inner side face 901 of the bucket 900.

The second lateral motion member 620 is a member movable in the lateral direction along an outer side face 902 of the bucket 900 while being in contact with the outer side face 902. In the example illustrated in FIG. 22, the second lateral motion member 620 includes at least one second roller 620r rolling on the outer side face 902 of the bucket 900. Alternatively or additionally, the second lateral motion member 620 may include at least one second slider that slides on the outer side face 902 of the bucket 900.

The third lateral motion member 630 is a member movable in the lateral direction along a top face 903 of the bucket 900 while being in contact with the top face 903. In the example illustrated in FIG. 22, the third lateral motion member 630 includes at least one third roller 630r rolling on the top face 903 of the bucket 900. Alternatively or additionally, the third lateral motion member 630 may include at least one third slider that slides on the top face 903 of the bucket 900.

The outer member 62 of the base unit 6 may have, in addition to the second lateral motion member 620, a manipulation part 622 that moves the second lateral motion member 620 forward and backward with respect to the outer side face 902 of the bucket 900. For example, the manipulation part 622 is subjected to a first manipulation, and thereby the second lateral motion member 620 can be pushed against the outer side face 902 of the bucket 900. Further, the manipulation part 622 is subjected to a second manipulation, and thereby the second lateral motion member 620 can be moved backward away from the outer side face 902 of the bucket 900.

In the example illustrated in FIG. 22, the base unit 6 has a catch member 624 that can be caught on a bottom face 904s of the top edge 904 of the bucket 900. In a state where the catch member 624 is caught on the bottom face 904s of the top edge 904 of the bucket 900, the tool support device 1B is prevented from rising from the bucket 900 (in other words, the third lateral motion member 630 is prevented from moving away from the top face 903 of the bucket 900).

In the example illustrated in FIG. 22, the outer member 62 of the base unit 6 has the catch member 624. The outer member 62 may have a catch member manipulation part 626 that moves the catch member 624 forward and backward with respect to the top edge 904 of the bucket 900. For example, the catch member manipulation part 626 is subjected to a third operation, and thereby the catch member 624 can be pushed against the top edge 904 of the bucket 900. Further, the catch member manipulation part 626 is subjected to a fourth operation, and thereby the catch member 624 can be moved backward away from the top edge 904 of the bucket 900.

As illustrated in FIG. 24 as an example, the base unit 6 may have a fixing member 66 (for example, a fixing pad) that positions and fixes the base unit 6 to the bucket 900 and a fixing member manipulation part 67. The fixing member manipulation part 67 moves the fixing member 66 forward and backward with respect to the bucket 900 (more specifically, the inner side face 901 of the bucket 900). For example, the fixing member manipulation part 67 is subjected to a fifth manipulation, and thereby the fixing member 66 (for example, a fixing pad) can be pushed against the bucket 900. Because the fixing member 66 is pushed against the bucket 900, the lateral motion of the base unit 6 is disabled, and the base unit 6 is fixed to the bucket 900. Further, the fixing member manipulation part 67 is subjected to a sixth operation, and thereby the fixing member 66 (for example, a fixing pad) can be moved backward away from the bucket 900.

In the example illustrated in FIG. 24, the inner member 61 of the base unit 6 has the fixing member 66 and the fixing member manipulation part 67.

### Third Arm Member 2c, Second Lock Mechanism 3f, Second Unlocking Member 4f

In the example illustrated in FIG. 20, the tool support device 1B has a third arm member 2c in addition to the first arm member 2a and the second arm member 2b. Further, as illustrated in FIG. 25 and FIG. 26 as an example, the tool support device 1B has the second lock mechanism 3f, the second unlocking member 4f, and a second wire W2 for manipulating the second unlocking member 4f.

The third arm member 2c is supported pivotably about the second axis AX2 by the second arm member 2b. For example, the second axis AX2 is parallel to the first axis AX1 (see FIG. 20).

The second lock mechanism 3f locks pivoting of the third arm member 2c relative to the second arm member 2b. Further, the second unlocking member 4f unlocks the pivoting of the third arm member 2c relative to the second arm member 2b locked by the second lock mechanism 3f.

The same mechanism as the first lock mechanism 3 described in the first embodiment may be employed as the second lock mechanism 3f, and the same member as the first unlocking member 4 described in the first embodiment may be employed as the second unlocking member 4f. In such a case, when the following replacement is applied in the description for the first lock mechanism 3 and the first unlocking member 4 of the first embodiment described above, the replaced description is regarded as the description for the second lock mechanism 3f and the second unlocking member 4f of the second embodiment.

More specifically, in the description for the first lock mechanism 3 and the first unlocking member 4 of the first embodiment described above, “tool support device 1A”, “first arm member 2a”, “second arm member 2b”, “first lock mechanism 3”, “first unlocking member 4”, “first friction plate 16, 161, 162”, “second friction plate 17, 171, 172”, “first guide part 26”, “pressing member 31” “engagement protruding part 32”, “first engagement protruding part 32-1”, “second engagement protruding part 32-2”, “pressed part 33”, “second engagement part 34”, “first pushing member 35”, “second guide part 36”, “first housing 37”, “first motion member 41”, “support member 43”, “second pushing member 45”, “annular recess 46”, “second shaft 215”, “end 216”, “pressing plate part 311”, “surface 312”, “outer circumferential face 313”, “first shaft 315”, “hollow portion 316”, “receiving member 317”, “engagement pin 321”, “engagement protrusion 323”, “surface 330”, “engagement hole 341”, “engagement recess 343”, “engagement groove 344”, “spring member 351”, “end plate 371”, “through hole 372”, “side wall 373”, “first end 411”, “second end 412”, “spring member 451”, “bottom wall 461”, “first axis AX1”, “first direction DR1”, “second direction DR2”, “first member M1”, “second member M2”, “one (N1) of the pressing member 31 and the pressed part 33”, “the other (N2) of the pressing member 31 and the pressed part 33”, “outer circumferential face N2s”, “first position P1”, “second position P2”, “receiving space SP”, “torque T”, and “first wire W1” are replaced with “tool support device 1B”, “second arm member 2b”, “third arm member 2c”, “second lock mechanism 3f”, “second unlocking member 4f”, “third friction plate 16f”, “fourth friction plate”, “third guide part 26f”, “second pressing member 31f” “third engagement protruding part 32f”, “engagement protruding part 32f-1”, “engagement protruding part 32f-2”, “second pressed part 33f”, “fourth engagement part 34f”, “third pushing member 35f”, “fourth guide part”, “second housing 37f”, “second motion member 41f”, “second support member 43f”, “fourth pushing member 45f”, “second annular recess 46f”, “fourth shaft 215f”, “end 216f”, “second pressing plate part 311f”, “surface 312f”, “outer circumferential face”, “third shaft 315f”, “hollow portion 316f”, “second receiving member 317f”, “third engagement pin 321f”, “third engagement protrusion”, “surface 330f”, “fourth engagement hole 341f”, “fourth engagement recess”, “fourth engagement groove”, “spring member 351f”, “end plate 371f”, “through hole 372f”, “side wall 373f”, “first end 411f”, “second end 412f”, “spring member 451f”, “bottom wall”, “second axis AX2”, “third direction DR3”, “fourth direction DR4”, “third member M3”, “fourth member M4”, “one (N3) of the second pressing member 31f and the second pressed part 33f”, “the other (N4) of the second pressing member 31f and the second pressed part 33f”, “outer circumferential face”, “third position P3”, “fourth position P4”, “receiving space SPf”, “torque Tf”, and “second wire W2”, respectively, and the replaced description is accordingly regarded as the description for the second lock mechanism 3f and the second unlocking member 4f of the second embodiment.

Note that it is obvious that, as the configurations related to the second lock mechanism 3f and the second unlocking member 4f, (A) the configuration illustrated in FIG. 2, FIG. 3, FIG. 7, and FIG. 8, (B) the configuration illustrated in FIG. 4, (C) the configuration illustrated in FIG. 5, (D) the configuration illustrated in FIG. 9 to FIG. 11, (E) the configuration illustrated in FIG. 12, (F) the configuration illustrated in FIG. 13, or (G) the configuration illustrated in FIG. 16 to FIG. 19 may be employed in the second embodiment instead of the configuration illustrated in FIG. 25 and FIG. 26.

In the example illustrated in FIG. 20, the tool support device 1B has a second joint part J2 that couples the second arm member 2b and the third arm member 2c to each other in a pivotable manner, and the plurality of third engagement protruding parts 32f described above (not illustrated in FIG. 20) and the plurality of fourth engagement parts 34f (not illustrated in FIG. 20) described above are arranged to the second joint part J2.

### Coupling Member 2d

In the example illustrated in FIG. 20, the tool support device 1B has a coupling member 2d coupled to the base unit 6. The coupling member 2d supports the first arm member 2a about a third axis AX3 in a pivotable manner. For example, the third axis AX3 is parallel to the first axis AX1. In the example illustrated in FIG. 20, the coupling member 2d couples the base unit 6 and the first arm member 2a to each other. The coupling member 2d may be rotatably coupled about a fourth axis AX4 to the base unit 6. In the example illustrated in FIG. 20, the fourth axis AX4 is an axis perpendicular to the third axis AX3. Further, the fourth axis AX4 is the vertical axis. FIG. 27 illustrates a view in which the coupling member 2d described above and a portion V supported by the coupling member 2d is pivotable about the fourth axis AX4 with respect to the base unit 6.

### Third Lock Mechanism 3g, Third Unlocking Member 4g

As illustrated in FIG. 28 and FIG. 29 as an example, the tool support device 1B may have the third lock mechanism 3g, the third unlocking member 4g, and a third wire W3 for manipulating the third unlocking member 4g.

The third lock mechanism 3g locks pivoting of the first arm member 2a relative to the coupling member 2d. Further, the third unlocking member 4g unlocks the pivoting of the first arm member 2a relative to the coupling member 2d locked by the third lock mechanism 3g.

The same mechanism as the first lock mechanism 3 described in the first embodiment may be employed as the third lock mechanism 3g, and the same member as the first unlocking member 4 described in the first embodiment may be employed as the third unlocking member 4g. In such a case, when the following replacement is applied in the description for the first lock mechanism 3 and the first unlocking member 4 of the first embodiment described above, the replaced description is regarded as the description for the third lock mechanism 3g and the third unlocking member 4g of the second embodiment.

More specifically, in the description for the first lock mechanism 3 and the first unlocking member 4 of the first embodiment described above, “tool support device 1A”, “first arm member 2a”, “second arm member 2b”, “first lock mechanism 3”, “first unlocking member 4”, “first friction plate 16, 161, 162”, “second friction plate 17, 171, 172”, “first guide part 26”, “pressing member 31” “engagement protruding part 32”, “first engagement protruding part 32-1”, “second engagement protruding part 32-2”, “pressed part 33”, “second engagement part 34”, “first pushing member 35”, “second guide part 36”, “first housing 37”, “first motion member 41”, “support member 43”, “second pushing member 45”, “annular recess 46”, “second shaft 215”, “end 216”, “pressing plate part 311”, “surface 312”, “outer circumferential face 313”, “first shaft 315”, “hollow portion 316”, “receiving member 317”, “engagement pin 321”, “engagement protrusion 323”, “surface 330”, “engagement hole 341”, “engagement recess 343”, “engagement groove 344”, “spring member 351”, “end plate 371”, “through hole 372”, “side wall 373”, “first end 411”, “second end 412”, “spring member 451”, “bottom wall 461”, “first axis AX1”, “first direction DR 1”, “second direction DR2”, “first member M1”, “second member M2”, “one (N1) of the pressing member 31 and the pressed part 33”, “the other (N2) of the pressing member 31 and the pressed part 33”, “outer circumferential face N2s”, “first position P1”, “second position P2”, “receiving space SP”, “torque T”, and “first wire W1” are replaced with “tool support device 1B”, “coupling member 2d”, “first arm member 2a”, “third lock mechanism 3g”, “third unlocking member 4g”, “fifth friction plate 16g”, “sixth friction plate”, “fifth guide part 26g”, “third pressing member 31g” “fifth engagement protruding part 32g”, “engagement protruding part 32g-1”, “engagement protruding part 32g-2”, “third pressed part 33g”, “sixth engagement part 34g”, “fifth pushing member 35g”, “sixth guide part”, “third housing 37g”, “third motion member 41g”, “third support member 43g”, “sixth pushing member 45g”, “third annular recess 46g”, “sixth shaft 215g”, “end 216g”, “third pressing plate part 311g”, “surface 312g”, “outer circumferential face”, “fifth shaft 315g”, “hollow portion 316g”, “third receiving member 317g”, “fifth engagement pin 321g”, “fifth engagement protrusion”, “surface 330g”, “sixth engagement hole 341g”, “sixth engagement recess”, “sixth engagement groove”, “spring member 351g”, “end plate 371g”, “through hole 372g”, “side wall 373g”, “first end 411g”, “second end 412g”, “spring member 451g”, “bottom wall”, “third axis AX3”, “fifth direction DR5”, “sixth direction DR6”, “fifth member M5”, “sixth member M6”, “one (N5) of the third pressing member 31g and the third pressed part 33g”, “the other (N6) of the third pressing member 31g and the third pressed part 33g”, “outer circumferential face”, “fifth position P5”, “sixth position P6”, “receiving space SPg”, “torque Tg”, and “third wire W3”, respectively, and the replaced description is accordingly regarded as the description for the third lock mechanism 3g and the third unlocking member 4g of the second embodiment.

Note that it is obvious that, as the configurations related to the third lock mechanism 3g and the third unlocking member 4g, (A) the configuration illustrated in FIG. 2, FIG. 3, FIG. 7, and FIG. 8, (B) the configuration illustrated in FIG. 4, (C) the configuration illustrated in FIG. 5, (D) the configuration illustrated in FIG. 9 to FIG. 11, (E) the configuration illustrated in FIG. 12, (F) the configuration illustrated in FIG. 13, or (G) the configuration illustrated in FIG. 16 to FIG. 19 may be employed in the second embodiment instead of the configuration illustrated in FIG. 28 and FIG. 29.

In the example illustrated in FIG. 20, the tool support device 1B has a third joint part J3 that couples the coupling member 2d and the first arm member 2a to each other in a pivotable manner, and the plurality of fifth engagement protruding parts 32g described above (not illustrated in FIG. 20) and the plurality of sixth engagement parts 34g (not illustrated in FIG. 20) described above are arranged to the third joint part J3.

Note that, although the tool support device 1B has three joint parts (J1, J2, J3) in the example illustrated in FIG. 20, it is obvious that the tool support device 1B may have two joint parts or four or more joint parts.

### Foot Pedal 7

In the example illustrated in FIG. 30, the tool support device 1B has the foot pedal 7. In the example illustrated in FIG. 31, the foot pedal 7 is connected to the first wire W1, the second wire W2, and the third wire W3 via a fourth wire W4.

In the example illustrated in FIG. 31, the example is configured such that, when the foot pedal 7 is manipulated, unlocking of pivoting of the second arm member 2b relative to the first arm member 2a, unlocking of pivoting of the third arm member 2c relative to the second arm member 2b, and unlocking of pivoting of the first arm member 2a relative to the coupling member 2d are performed at once.

More specifically, in the example illustrated in FIG. 31, when the foot pedal 7 is manipulated (more specifically, the foot pedal 7 is depressed and manipulated), the first wire W1 coupled to the fourth wire W4 is pulled, the tension of the first wire W1 is increased. When the tension of the first wire W1 is increased, the first wire W1 manipulates the first motion member 41. Further, the first motion member 41 manipulated by the first wire W1 moves the pressing member 31 in the second direction DR2 (see FIG. 15 and the like). In such a way, pivoting of the second arm member 2b relative to the first arm member 2a is unlocked. Note that, when the tool support device 1B has the friction plate (16, 17), due to the unlocking, the second arm member 2b is not pivoted at a high speed about the first axis AX1.

In the example illustrated in FIG. 31, when the foot pedal 7 is manipulated (more specifically, the foot pedal 7 is depressed and manipulated), the second wire W2 coupled to the fourth wire W4 is pulled, the tension of the second wire W2 is increased. When the tension of the second wire W2 is increased, the second wire W2 manipulates the second unlocking member 4f (more specifically, the second motion member 41f). Further, the second unlocking member 4f (more specifically, the second motion member 41f) manipulated by the second wire W2 moves the second pressing member 31f in the fourth direction DR4 (see FIG. 26). In such a way, pivoting of the third arm member 2c relative to the second arm member 2b is unlocked. Note that, when the tool support device 1B has a friction plate such as the third friction plate 16f, due to the unlocking, the third arm member 2c is not pivoted at a high speed about the second axis AX2.

In the example illustrated in FIG. 31, when the foot pedal 7 is manipulated (more specifically, the foot pedal 7 is depressed and manipulated), the third wire W3 coupled to the fourth wire W4 is pulled, and the tension of the third wire W3 is increased. When the tension of the third wire W3 is increased, the third wire W3 manipulates the third unlocking member 4g (more specifically, the third motion member 41g). Further, the third unlocking member 4g (more specifically, the third motion member 41g) manipulated by the third wire W3 moves the third pressing member 31g in the sixth direction DR6 (see FIG. 29). In such a way, pivoting of the first arm member 2a relative to the coupling member 2d is unlocked. Note that, when the tool support device 1B has a friction plate such as the fifth friction plate 16g, due to the unlocking, the first arm member 2a is not pivoted at a high speed about the third axis AX3.

FIG. 32 illustrates an example of a view in which adjustment of the angle of the first arm member 2a relative to the coupling member 2d, adjustment of the angle of the second arm member 2b relative to the first arm member 2a, and adjustment of the angle of the third arm member 2c relative to the second arm member 2b are performed in a state where the locking applied by the first lock mechanism 3, the locking applied by the second lock mechanism 3f, and the locking applied by the third lock mechanism 3g have been released. With the adjustment of these angles, the position of the distal end of the tool support device 1B is adjusted.

When three locking actions applied by three locking mechanisms are released at once, the operator is able to efficiently adjust the position of the distal end of the tool support device 1B. Further, when three locking actions applied by three locking mechanisms are released at once by using the foot pedal 7, the operator is able to adjust the position of the distal end of the tool support device 1B efficiently and stably by using both hands.

The foot pedal 7 may be a toggle type foot pedal. In such a case, once the foot pedal 7 is depressed, locking of each of the three lock mechanisms is released (in other words, three joint parts (J1, J2, J3) are unlocked), and when the foot pedal 7 is again depressed, locking of each of the three lock mechanisms is activated (in other words, three joint parts (J1, J2, J3) are locked).

Note that the foot pedal 7 may be replaced with a hand lever. In other words, the embodiment may be configured such that unlocking of pivoting of the second arm member 2b relative to the first arm member 2a, unlocking of pivoting of the third arm member 3c relative to the second arm member 2b, and unlocking of pivoting of the first arm member 2a relative to the coupling member 2d to be performed at once by manipulation of the hand lever.

In the example illustrated in FIG. 31, any of the receiving member 317, the second receiving member 317f, and the third receiving member 317g may be repositioned from the advanced position (P1; P3; P5) to the retracted position (P2; P4; P6). When any receiving member (317; 317f; 317g) is repositioned to the retracted position, a joint part not requiring angle adjustment can be fixed. In other words, by changing the positions of the receiving members (317; 317f; 317g), it is possible to set a joint part that is unlocked by manipulation of the foot pedal 7 or a hand lever and a joint part that is not unlocked by manipulation of the foot pedal 7 or a hand lever.

Alternatively, the foot pedals 7 (or hand levers) the number of which corresponds to the number of lock mechanisms (3; 3f; 3g) may be prepared. In the example illustrated in FIG. 33, the first unlocking member 4 (more specifically, the first motion member 41) and a first foot pedal 7-1 are connected to each other via the first wire W1, the second unlocking member 4f (more specifically, the second motion member 41f) and a second foot pedal 7-2 are connected to each other via the second wire W2, and the third unlocking member 4g (more specifically, the third motion member 41g) and a third foot pedal 7-3 are connected to each other via the third wire W3. In such a case, each foot pedal (7-1; 7-2; 7-3) is manipulated, and thereby the lock mechanisms (3; 3f; 3g) can be individually manipulated. Note that each foot pedal is preferably a toggle type foot pedal.

In the second embodiment, the example in which the unlocking member (4; 4g; 4f) is manipulated by a wire has been described. Alternatively, the unlocking member (4; 4g; 4f) may be manipulated by using hydraulic pressure.

### Third Embodiment

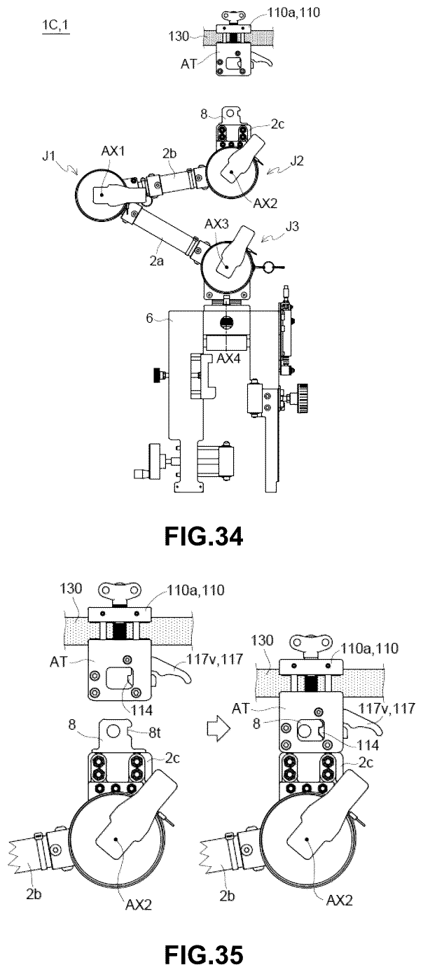

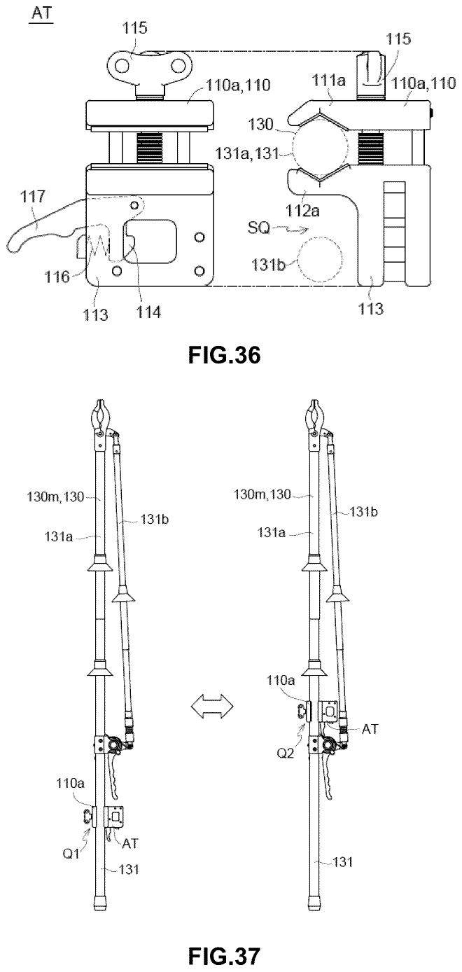

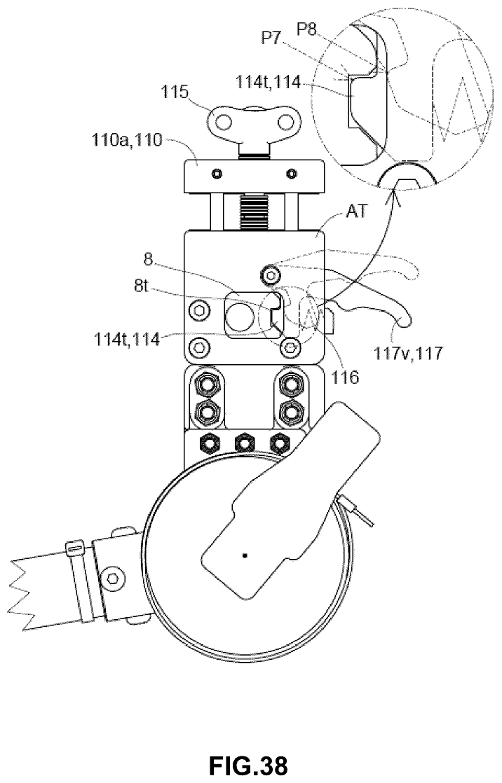

A tool support device 1C of a third embodiment will be described with reference to FIG. 1 to FIG. 38. FIG. 34 is a general side view schematically illustrating the tool support device 1C of the third embodiment. FIG. 35 is a diagram schematically illustrating a view in which an attachment AT is attached to an attachment part 8 of the tool support device 1C with one-touch operation. FIG. 36 is a general two-side view schematically illustrating an example of the attachment AT. Note that a general side view is illustrated on the left side in FIG. 36, and a general front view is illustrated on the right side in FIG. 36. FIG. 37 is a diagram illustrating a view in which the attachment AT can be selectively attached to a first portion Q1 of a remote manipulation tool 130m or a second portion Q2 of a remote manipulation tool 130m. FIG. 38 is a diagram illustrating a view in which an engagement member 114 of the attachment AT can be repositioned between an advanced position P7 that enables engagement with the attachment part 8 and a retracted position P8 that disables engagement with the attachment part 8 of the tool support device 1C.

In the third embodiment, features different from the first embodiment and the second embodiment will be mainly described, and duplicated description for features that have already been described in the first embodiment or the second embodiment will be omitted. It is therefore obvious that, even when not explicitly described in the third embodiment, the features that have already been described in the first embodiment or the second embodiment can be employed in the third embodiment.

As illustrated in FIG. 34 as an example, the tool support device 1C of the third embodiment includes the attachment AT having a gripping tool 110a and the attachment part 8 to which the attachment AT is attached. Note that the gripping tool 110a can grip a further tool 130.

As illustrated in FIG. 34 as an example, the tool support device 1C includes (1) the first arm member 2a, (2) the second arm member 2b, (3) a first lock mechanism, and (4) a first unlocking member. Since “first arm member 2a”, “second arm member 2b”, “first lock mechanism”, and “first unlocking member” have already been described in the first embodiment or the second embodiment, duplicated description for these features will be omitted.

As illustrated in FIG. 34 as an example, the attachment part 8 of the tool support device 1C may be arranged in the third arm member 2c. Alternatively, the attachment part 8 of the tool support device 1C may be arranged in the second arm member 2b or may be arranged in other members.

In the example illustrated in FIG. 35, it is possible to attach the attachment AT having the gripping tool 110a to the attachment part 8 described above with one-touch operation.

When the tool support device 1C has the attachment AT described above, it is possible to quickly and easily perform the operation to attach the gripping tool 110a to the attachment part 8 of the tool support device 1C. For example, it is possible to quickly and easily attach the gripping tool 110a to the attachment part 8 of the tool support device 1C with the further tool 130 being gripped by the gripping tool 110a.

Next, optional, additional configurations that can be employed in the tool support device 1C of the third embodiment will be described with reference to FIG. 1 to FIG. 38.

### Attachment AT

In the example illustrated in FIG. 36, the attachment AT has the gripping tool 110a, a base portion 113 in which the engagement member 114 engaged with the attachment part 8 is arranged, a pushing member 116, and a manipulation member 117.

In the example illustrated in FIG. 36, the gripping tool 110a has a first gripping part 111a, a second gripping part 112a, and a second manipulation member 115 for adjusting the gap between the first gripping part 111a and the second gripping part 112a. When the second manipulation member 115 is manipulated, the gap between the first gripping part 111a and the second gripping part 112a is reduced. In such a way, the further tool 130 arranged between the first gripping part 111a and the second gripping part 112a is gripped by the first gripping part 111a and the second gripping part 112a.

In the example illustrated in FIG. 36, the gripping tool 110a (more specifically, the first gripping part 111a and the second gripping part 112a) can grip a rod-like part 131 of the further tool 130 (for example, a primary rod 131a of the further tool 130). As illustrated in FIG. 37 as an example, it is preferable for the gripping tool 110a to be able to selectively grip the first portion Q1 of the rod-like part 131 of the further tool 130 (for example, the proximal end of the rod-like part 131) and the second portion Q2 of the rod-like part 131 of the further tool 130 (for example, a portion on the distal end side from the proximal end of the rod-like part 131).

As illustrated in FIG. 36 as an example, the second gripping part 112a of the gripping tool 110a may be arranged in the base portion 113 of the attachment AT. More specifically, the second gripping part 112a may be formed integrally with the base portion 113, or the second gripping part 112a may be attached to the base portion 113.

In the example illustrated in FIG. 38, the engagement member 114 can be repositioned between the advanced position P7 that enables engagement with the attachment part 8 and the retracted position P8 that disables engagement with the attachment part 8. For example, the engagement member 114 includes an engagement projection 114t. Further, for example, the attachment part 8 includes an engagement recess 8t that can be engaged with the engagement projection 114t.

The pushing member 116 pushes the engagement member 114 in a direction from the retracted position P8 to the advanced position P7. In such a case, in a state where no manipulation force is applied to the manipulation member 117, the position of the engagement member 114 is maintained at the advanced position P7 by the pushing force of the pushing member 116. For example, the pushing member 116 is a spring (more specifically, a coil spring or a torsional coil spring).

The manipulation member 117 moves the engagement member 114 from the advanced position P7 to the retracted position P8 against the pushing force of the pushing member 116. For example, the manipulation member 117 includes a manipulation lever 117v.

In the example illustrated in FIG. 35, the example is configured such that, when the attachment AT is pushed against the attachment part 8, the attachment AT is automatically attached to the attachment part 8. More specifically, the example is configured such that, when the attachment AT is pushed against the attachment part 8, the attachment part 8 temporarily moves the engagement member 114 to the retracted position, and the engagement member 114 then returns to the advanced position by the pushing force of the pushing member 116. Due to this movement, the engagement member 114 of the attachment AT is engaged with the attachment part 8 of the tool support device 1C (more specifically, the engagement recess 8t), and thereby the attachment AT is attached to the attachment part 8 of the tool support device 1C.

In the example illustrated in FIG. 35, the attachment AT is detachable with respect to the attachment part 8 of the tool support device 1C with the attachment AT being attached to the further tool 130. It is therefore possible to handle the further tool 130 and the attachment AT as an integrated assembly. For example, the further tool 130 can be carried with the attachment AT being attached to the further tool 130. Further, the attachment AT attached to the further tool 130 can be attached to the attachment part 8 of the tool support device 1C with one-touch operation.

### Further Tool 130

In the example illustrated in FIG. 37, the further tool 130 gripped by the gripping tool 110a of the attachment AT is the remote manipulation tool 130m having a gripping part or a cutting part at the distal end. Further, the remote manipulation tool 130m has the primary rod 131a and a secondary rod 131b. Each of the primary rod 131a and the secondary rod 131b may be an electrically insulating insulator manipulation rod.

In the example illustrated in FIG. 36, the second gripping part 112a of the attachment AT is configured so as to be insertable between the primary rod 131a and the secondary rod 131b of the remote manipulation tool 130m. More specifically, the attachment AT has a secondary-rod margin space SQ defined by the second gripping part 112a and the base portion 113. Further, the secondary-rod margin space SQ, the second gripping part 112a, and the first gripping part 111a are arranged so as to be aligned in one straight line. Due to the presence of the secondary-rod margin space SQ the motion of the secondary rod 131b (in other words, manipulation of the secondary rod 131b) is not obstructed by the attachment AT in a state where the primary rod 131a is gripped by the gripping tool 110a.

Note that, in the embodiment, the further tool 130 gripped by the gripping tool 110a of the attachment AT may be a tool other than the remote manipulation tool. Further, an object other than a tool may be gripped by the gripping tool 110a of the attachment AT.

It is apparent that the present invention is not limited to each embodiment or each modified example described above and each embodiment or each modified example may be modified or changed as appropriate within the scope of the technical concept of the present invention. Further, any component used in each embodiment or each modified example can be combined with another embodiment or another modified example, or any component can be omitted in each embodiment or each modified example.

### INDUSTRIAL APPLICABILITY

The use of the tool support device of the present invention makes it possible to easily perform fixing of the angle of the second arm relative to the first arm and adjustment of the angle. This can facilitate position adjustment of a tool. Therefore, the tool support device of the present invention is useful for business entities that perform operations using a tool supported by a tool support device or manufacturers that manufacture tool support devices.

### LIST OF REFERENCE SYMBOLS

1, 1A, 1B, 1C tool support device
2a first arm member
2b second arm member
2c third arm member
2d coupling member
3 first lock mechanism
3f second lock mechanism
3g third lock mechanism
4 first unlocking member
4f second unlocking member
4g third unlocking member
6 base unit
7 foot pedal
7-1 first foot pedal
7-2 second foot pedal
7-3 third foot pedal
8 attachment part
8t engagement recess
16 first friction plate
16f third friction plate
16g fifth friction plate
17 second friction plate
26 first guide part
26f third guide part
26g fifth guide part
31 pressing member
31f second pressing member
31g third pressing member
32 engagement protruding part
32-1 first engagement protruding part
32-2 second engagement protruding part
32f third engagement protruding part
32f-1, 32f-2 engagement protruding part
32g fifth engagement protruding part
32g-1, 32g-2 engagement protruding part
33 pressed part
33f second pressed part
33g third pressed part
34 second engagement part
34f fourth engagement part
34g sixth engagement part
35 first pushing member
35f third pushing member
35g fifth pushing member
36 second guide part
37 first housing
37f second housing
37g third housing
41 first motion member
41f second motion member
41g third motion member
43 support member
43f second support member
43g third support member
45 second pushing member
45f fourth pushing member
45g sixth pushing member
46 annular recess
46f second annular recess
46g third annular recess
61 inner member
62 outer member
63 upper member
66 fixing member
67 fixing member manipulation part
110 tool
110a gripping tool
111a first gripping part
112a second gripping part
113 base portion
114 engagement member
114t engagement projection
115 second manipulation member
116 pushing member
117 manipulation member
117v manipulation lever
130 further tool
130m remote manipulation tool
131 rod-like part
131a primary rod
131b secondary rod
161, 162 first friction plate
171, 172 second friction plate
215 second shaft
215f fourth shaft
215g sixth shaft
216 end of the second shaft
216f end of the fourth shaft
216g end of the sixth shaft
311 pressing plate part
311f second pressing plate part
311g third pressing plate part
312 surface on the first direction side of the pressing member
312f surface on the third direction side of the second pressing member
312g surface on the fifth direction side of the third pressing member
313 outer circumferential face of the pressing member
315 first shaft
315f third shaft
315g fifth shaft
316, 316f, 316g hollow portion
317 receiving member
317f second receiving member
317g third receiving member
321 engagement pin
321f third engagement pin
321g fifth engagement pin
323 engagement protrusion
330 surface on the second direction side of the pressed part
330f surface on the fourth direction side of the pressed part
330g surface on the sixth direction side of the pressed part
341 engagement hole
341f fourth engagement hole
341g sixth engagement hole
343 engagement recess
344 engagement groove
351, 351f, 351g spring member
371 end plate of the housing
371f end plate of the second housing
371g end plate of the third housing
372, 372f, 372g through hole
373 side wall of the housing
373f side wall of the second housing
373g side wall of the third housing
411 first end of the first motion member
411f first end of the second motion member
411g first end of the third motion member
412 second end of the first motion member
412f second end of the second motion member
412g second end of the third motion member
451, 451f, 451g spring member
461 bottom wall of the annular recess
610 first lateral motion member
610r first roller
620 second lateral motion member
620r second roller
622 manipulation part
624 catch member
626 catch member manipulation part
630 third lateral motion member
630r third roller
900 bucket
901 inner side face of the bucket
902 outer side face of the bucket
903 top face of the bucket
904 top edge of the bucket
904s bottom face of the top edge of the bucket
AT attachment
AX1 first axis
AX2 second axis
AX3 third axis
AX4 fourth axis
J1 first joint part
J2 second joint part
J3 third joint part
M1 first member
M2 second member
M3 third member
M4 fourth member
M5 fifth member
M6 sixth member
N2s outer circumferential face
SP, SPf, SPg receiving space
SQ secondary-rod margin space
W1 first wire
W2 second wire
W3 third wire
W4 fourth wire

1. A tool support device comprising:
a first arm member;
a second arm member supported pivotably by the first arm member;
a first lock mechanism configured to lock pivoting of the second arm member relative to the first arm member by engagement between a plurality of engagement protruding parts and a plurality of second engagement parts; and
a first unlocking member configured to unlock the pivoting of the second arm member relative to the first arm member locked by the first lock mechanism,
wherein the first lock mechanism has
when one of the first arm member and the second arm member is defined as a first member, and the other of the first arm member and the second arm member is defined as a second member, a pressing member coupled to the second member so as to be nonrotatable relative to and linearly movable relative to the second member,
a pressed part arranged in the first member and pressed by the pressing member,
the plurality of engagement protruding parts arranged on one of the pressing member and the pressed part,
the plurality of second engagement parts arranged in the other of the pressing member and the pressed part, and
a first pushing member configured to push the pressing member in a first direction toward the pressed part so that the engagement between the plurality of engagement protruding parts and the plurality of second engagement parts is maintained, and
wherein the first unlocking member includes a first motion member configured to move the pressing member in a second direction opposite to the first direction against pushing force applied by the first pushing member.

2. The tool support device according to claim 1,
wherein the first arm member supports the second arm member so that the second arm member is pivotable about a first axis parallel to the first direction, and
wherein the engagement between the plurality of engagement protruding parts and the plurality of second engagement parts supports at least a part of torque about the first axis acting on the first arm member from the second arm member.

3. The tool support device according to claim 2, wherein the plurality of second engagement parts include a plurality of engagement holes that receive the plurality of engagement protruding parts or a plurality of engagement recesses that receive the plurality of engagement protruding parts.

4. The tool support device according to claim 2, wherein the plurality of second engagement parts are arranged at equal angular intervals about the first axis.

5. The tool support device according to claim 1 further comprising a friction plate coupled to the first member so as to be nonrotatable relative to and linearly movable relative to the first member,
wherein the first pushing member presses the pressing member in the first direction via the friction plate.

6. The tool support device according to claim 2 further comprising:
a first friction plate; and
a second friction plate in contact with the first friction plate,
wherein the first friction plate is rotatable relative to the pressing member about the first axis, is nonrotatable relative to the pressed part about the first axis, and is movable relative to the pressed part in a direction parallel to the first axis,
wherein the second friction plate is rotatable relative to the pressed part about the first axis, is nonrotatable relative to the pressing member about the first axis, and is movable relative to the pressed part in a direction parallel to the first axis, and
wherein the first pushing member presses the pressing member in the first direction via the first friction plate and the second friction plate.

7. The tool support device according to claim 1 further comprising a second pushing member configured to push the pressing member in the second direction,
wherein second pushing force of the second pushing member is smaller than the pushing force of the first pushing member.

8. The tool support device according to claim 1,
wherein the pressing member has a receiving member that receives acting force from the first motion member, and
wherein the receiving member is configured to be repositioned between a first position and a second position, the first position enabling motion of the first motion member to be converted into unlocking of pivoting of the second arm member relative to the first arm member, and the second position disabling the motion of the first motion member to be converted into unlocking of pivoting of the second arm member relative to the first arm member.

9. The tool support device according to claim 1 further comprising a first wire for manipulating the first motion member.

10. The tool support device according to claim further comprising a base unit configured to be directly attached to a bucket of an aerial work platform,
wherein in a state where the base unit is directly attached to the bucket, the entire base unit is configured so as to be slidably movable with respect to the bucket.

11. The tool support device according to claim 10,
wherein the base unit has
a first lateral motion member movable in a lateral direction along an inner side face while being in contact with the inner side face of the bucket,
a second lateral motion member movable in a lateral direction along an outer side face while being in contact with the outer side face of the bucket, and
a third lateral motion member movable in a lateral direction along a top face while being in contact with the top face of the bucket.

12. The tool support device according to claim 9 further comprising:
a third arm member supported pivotably about a second axis by the second arm member;
a second lock mechanism configured to lock pivoting of the third arm member relative to the second arm member;
a second unlocking member configured to unlock the pivoting of the third arm member relative to the second arm member locked by the second lock mechanism;
a second wire for manipulating the second unlocking member;
a base unit;
a coupling member coupled to the base unit and configured to support the first arm member pivotably about a third axis;
a third lock mechanism configured to lock pivoting of the first arm member relative to the coupling member;
a third unlocking member configured to unlock the pivoting of the first arm member relative to the coupling member locked by the third lock mechanism;
a third wire for manipulating the third unlocking member; and
a foot pedal or a hand lever connected to the first wire, the second wire, and third wire via a fourth wire,
wherein the tool support device is configured such that unlocking of pivoting of the second arm member relative to the first arm member, unlocking of pivoting of the third arm member relative to the second arm member, and unlocking of pivoting of the first arm member relative to the coupling member are performed at once by manipulation of the foot pedal or the hand lever.

13. The tool support device according to claim 1, to further comprising:
an attachment having a gripping tool; and
an attachment part, the attachment being configured to be attached to the attachment part,
wherein the attachment is configured to be attached to the attachment part with one-touch operation.

14. The tool support device according to claim 2 further comprising a first wire for

15. The tool support device according to claim 3 further comprising a first wire for manipulating the first motion member.

16. The tool support device according to claim 4 further comprising a first wire for manipulating the first motion member.

17. The tool support device according to claim 5 further comprising a first wire for manipulating the first motion member.

18. The tool support device according to claim 6 further comprising a first wire for manipulating the first motion member.

19. The tool support device according to claim 7 further comprising a first wire for manipulating the first motion member.

20. The tool support device according to claim 8 further comprising a first wire for manipulating the first motion member.
